(19) United States
(12) Patent Application Publication
(10) Pub. No.: US 2005/0198624 A1
(43) Pub. Date: Sep. 8, 2005

(54) Method and system for program transformation

(76) Inventor: Timothy W. Chipman, Irvine, CA (US)

Correspondence Address: KLEIN, O'NEILL & SINGH, 2 PARK PLAZA, SUITE 510, IRVINE, CA, 92614, US

(21) Appl. No.: 10/931,539

(22) Filed: Sep. 1, 2004

Related U.S. Application Data
(63) Continuation-in-part of application No. 10/791,110, filed on Mar. 2, 2004.

(51) Int. Cl. G06F 9/45

(52) U.S. Cl. 717/146

(57) ABSTRACT

A method and system method for analyzing calls in an executable computer program is provided. The process determines if a call is intercepted in a native processor code; analyzes intermediate language code of a function if the call is not intercepted in the native processor code; and checks each function for an exception clause. The process also determines if a call is implemented in a managed code or a native processor code; searches for an existing call to a function if the call is implemented in the managed code; adds a new call record if the call does not exist; and links an outgoing argument of the call to an incoming argument of the call. The process also determines if a link between a target node and source node already exists; and creates a link between a target node and a source node if the link does not exist.

### CROSS REFERENCE TO RELATED APPLICATION

This patent application is a continuation-in-part of the patent application filed on Mar. 2, 2004, Ser. No. 10/791,110; the disclosure of which is incorporated herein by reference in its entirety.

### BACKGROUND OF THE INVENTION

1. Field of the Invention

The present invention relates to embedded systems, and more particularly, to efficient programming techniques used in embedded systems.

2. Background

MRTE is a platform that abstracts the specifics of an operating system and the architecture running underneath it. Instead of writing programs that directly command a processor, software developers write to a “runtime” that handles many of the generic tasks that programmers used to have to anticipate and build. Managed runtime can handle tasks like heap management, security, garbage collection, and memory allocation. This allows developers to concentrate on business logic specific to their application. Because of runtime's close relationship with the operating system and architecture, it's often called a “virtual machine.”

Several MRTEs have been commercialized, including IBM's SmallTalk™ language and runtime, Sun Microsystem's Java™ language and runtime, and Microsoft's .NET™ common language runtime (referred to as “CLR”).

Object-oriented programming languages used in MRTEs provide a number of features such as classes, class members, multiple inheritance, and virtual functions. These features enable the creation of class libraries that can be reused in many different applications. However, such code reuse comes at a price. In order to facilitate reusability, OOP encourages the design of classes that incorporate a high degree of functionality. Programs that use a class library typically exercise only a part of the library's functionality. Such a program may pay a memory penalty for library functionality that it does not use.

A library may contain dead executable code. Dead executable code is code that is not executed during execution of the program, or code whose execution cannot affect the program's observable behavior. Dead executable code in an application adversely affects memory requirements and is hence undesirable. Dead executable code may also take the form of unused library procedures.

Virtual functions are operations that are declared in a base class, but may have different implementations in subclasses. Typically, virtual functions count for a substantial portion of dead executable code. When program code that is written to operate on any object (either an object of the base class or any of its subclasses) makes method calls, the correct implementation of the method in question must be used. As a result, no fixed code address can be associated with that method call—a different address must be used depending on the particular (sub)class to which the object belongs. [S. Bhakthavatsalam, “Measuring the Perceived Overhead Imposed by Object-Oriented Programming in a Real-time Embedded System”, Blacksburg, Va., May 16, 2003].

Prior art has addressed the problem of eliminating some, but not all unused virtual functions. An example of such prior art is provided in the white papers by D. F. Bacon and Peter F. Sweeney, “Fast Static Analysis of C++ Virtual Function Calls”, IBM Watson Research Center, and by A. Srivastava, “Unused procedures in object-oriented programming”, ACM Letters on Programming Languages and Systems, 1(4), pp. 355-364.

Such prior art methods only partially eliminate non-virtual functions, and hence, the problem of dead code still remains.

Other prior art technique address eliminating virtual functions in MRTEs by performing inter-procedural analysis of object types; as discussed by I. Pechtchanski and V. Sarkar, in “Dynamic Optimistic Interprocedural Analysis: a Framework and an Application”.

Such techniques track object types at a global level and do not take into consideration the possible variance of object types based on specific instructions within specific functions called by specific execution paths. For example, such conventional techniques track a local variable type that may be limited to say A or B during the lifetime of the program but do not track a local variable type that is exactly B at a specific instruction following a specific execution path. For field access, such conventional techniques track say field F of class T that may be limited to A or B during the lifetime of the program, but do not track that instance Q of class T that has field F always set to B at a specific instruction following a specific execution path. In practice, this is very significant, as such prior art approaches yield exponentially larger sets of included functions that are never called.

Conventional techniques are flow insensitive and not flow sensitive. Flow insensitive approach tracks variable types globally (at a program level), without giving any consideration to how a variable is used at a specific instruction of a specific function and call path.

These issues are magnified when considering modern MRTEs that specify extensive standard framework libraries with millions of virtual function calls and deep inheritance chains such as Microsoft's .NET®. Using prior art methods in practice, a program that calls into a simple framework function such as formatting a text string yields dependencies on thousands of downstream virtual functions that are never called effectively, and string formatting functions are included for every instantiated object type, regardless if these functions are actually used.

Modem MRTEs primarily reside in personal computers or handheld environments with enough memory to easily hold entire class libraries (in the order of 64 megabytes). Such environments are typically used in an environment where multiple application programs use common class libraries and underlying operating system functions. Because of the nature of these environments, it is beneficial for performance and interoperability to maintain a single set of class libraries that are shared across applications in their complete form. Thus, there is limited, if any, benefit of determining dead executable code in such environments.

However, dead code becomes a major problem for smaller systems, for example, embedded systems, because memory is extremely limited, and such devices typically perform a specific application and do need to use a massive single set of class libraries. An example of one such embedded system is the Lantronix XPORT™ sold by Lantronix Inc.

Besides dead code issues, prior art does not provide an efficient way of handling program calls, i.e., call interception and re-direction. Also, the program image as executed in an embedded system is often large and cumbersome. Translation of code from an intermediate language to a native processor is also inefficient.

Therefore, there is a need for a system and method for efficiently executing a program functions in the MRTE environment.

### SUMMARY OF THE INVENTION

In one aspect of the present invention, a method for analyzing calls in an executable computer program is provided. The method includes, determining if a call is intercepted in a native processor code; analyzing intermediate language code of a function if the call is not intercepted in the native processor code; and checking each function for an exception clause. The method also includes, determining type behavior of the call if the call is intercepted in the native processor code.

In another aspect of the present invention, a method for registering calls in an executable computer program is provided. The method includes, determining if a call is implemented in a managed code or a native processor code; searching for an existing call to a function if the call is implemented in the managed code; adding a new call record if the call does not exist; and linking an outgoing argument of the call to an incoming argument of the call.

In yet another aspect of the present invention, a method for linking nodes in a program to designate a source to target relationship is provided. The method includes, determining if a link between a target node and source node already exists; and creating a link between a target node and a source node if the link does not exist.

In another aspect of the present invention, a method for resolving virtual functions calls in a computer program is provided. The method includes resolving a target function for a given virtual function; registering a call to the target function; and iterating an implicit type.

In another aspect of the present invention, a method for handling direct calls to a function is provided. The method includes, registering a call to a target function; initializing a value node for each type; and linking the value node to an argument node of the target function.

In yet another aspect of the present invention, a method for handling virtual functional calls in a program is provided. The method includes, determining if a type containing the virtual function call is marked as sealed; registering metadata for virtual function if the virtual function call is not marked as sealed; and creating a virtual call block record.

In another aspect of the present invention, a method for registering a metadata routine in a program is provided. The method includes, determining if a local token describes an external reference table; and resolving a reference module by name if the local token describes an external reference table.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

The foregoing features and other features of the present invention will now be described. In the drawings, the same components have the same reference numerals. The illustrated embodiment is intended to illustrate, but not to limit the invention. The drawings include the following Figures:

FIG. 1 is a block diagram of the internal architecture of a system using the executable process steps, according to one aspect of the present invention;

FIG. 2 is a block diagram showing intermediate language with respect to source code and native processor code;

FIG. 3 shows a flow diagram of the overall process flow diagram for executing a program using a computing system, according to one aspect of the present invention;

FIG. 4 shows a flow diagram of executable process steps for registering calls, according to one aspect of the present invention;

FIG. 5 shows a flow diagram for analyzing calls, according to one aspect of the present invention;

FIG. 6 shows a flow diagram for testing relevant instructions in IL code, according to one aspect of the present invention;

FIG. 7 shows a flow diagram for linking nodes, according to one aspect of the present invention;

FIG. 8 shows a flow diagram for linking sub-nodes, according to one aspect of the present invention;

FIG. 9 shows a flow diagram for resolving virtual function calls, according to one aspect of the present invention;

FIG. 10 shows a flow diagram of process steps for handling direct calls to functions;

FIG. 11 shows a flow diagram for handling virtual functional calls, according to one aspect of the present invention;

FIG. 12 shows a flow diagram for instantiating objects, according to one aspect of the present invention;

FIG. 13 shows a flow diagram for using a “New Array” instruction for creating single-dimension zero-based arrays, according to one aspect of the present invention;

FIG. 14 shows a flow diagram for using the “Get Subnode” routine, according to one aspect of the present invention;

FIG. 15 shows a flow diagram for using the Set Subnode instruction, according to one aspect of the present invention;

FIG. 16 shows a flow diagram for using the “Load Static Field” (“LDSFLD”) instruction, according to one aspect of the present invention;

FIG. 17 shows a flow diagram for using the Load Token instruction, according to one aspect of the present invention;

FIG. 18 shows a flow diagram for using the ‘Get Stack Node” routine, according to one aspect of the present invention;

FIG. 19 shows a flow diagram for using the ‘Set Stack Node” routine, according to one aspect of the present invention;

FIG. 20 shows a flow diagram for using the ‘Get Stack Address” routine, according to one aspect of the present invention;

FIG. 21 shows a flow diagram for using the “Load String” (“LDSTR”) function, according to one aspect of the present invention;

FIG. 22 shows a flow diagram for using the “Box” instruction, according to one aspect of the present invention;

FIG. 23 shows a flow diagram for using the “Return” (“RET”) instruction, according to one aspect of the present invention;

FIG. 24 shows a flow diagram for using the “Duplicate” (‘DUP”) instruction, according to one aspect of the present invention;

FIG. 25 shows a flow diagram for using the “Throw” instruction, according to one aspect of the present invention;

FIG. 26 shows a flow diagram for using the “Link Arguments” routine, according to one aspect of the present invention;

FIG. 27 shows a flow diagram for using the “Add Call to List” routine, according to one aspect of the present invention;

FIG. 28 shows a flow diagram for using the “Catch Clause” routine, according to one aspect of the present invention;

FIGS. 29A and 29B show various data structures used by the adaptive aspects of the present invention; and

FIG. 30 shows a process flow diagram for executing the “Register Metadata” routine, according to one aspect of the present invention.

### DETAILED DESCRIPTION OF THE PREFERRED EMBODIMENTS

To facilitate an understanding of the preferred embodiment, the general architecture and operation of a computing system (including embedded systems) will initially be described. The specific architecture and operation of the preferred embodiment will then be described with reference to the general architecture.

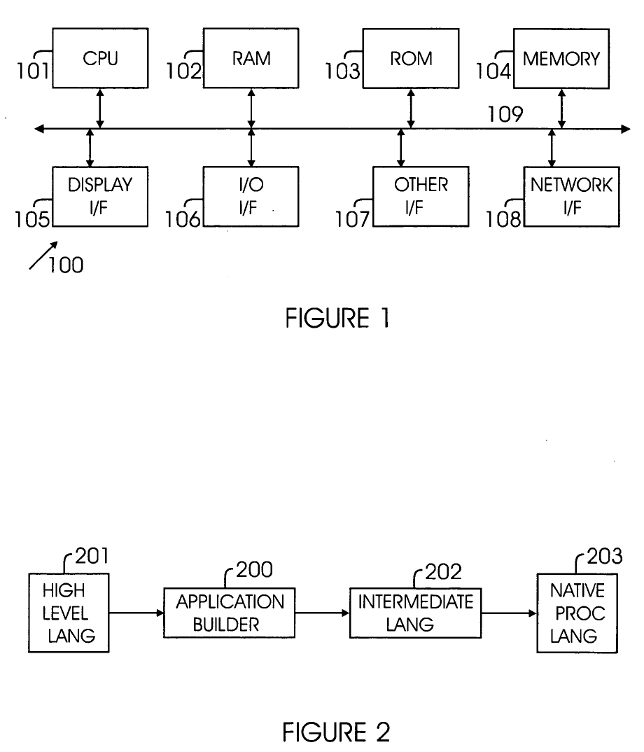

FIG. 1 is a block diagram of an embedded system for executing computer executable process steps according to one aspect of the present invention. In FIG. 1, system 100 includes a central processor (“CPU”) 101 for executing computer-executable process steps and interfaces with a computer bus 109. A Pentium® based processor may be used as CPU 101. The invention is not limited to any particular type or speed of processor 101.

Memory 104 stores operating system program files, application program files, and other files. Some of these files are stored on using an installation program. For example, CPU 101 executes computer-executable process steps of an installation program so that CPU 101 can properly execute the application program.

Random access memory (“RAM”) 102 also interfaces to bus 109 to provide CPU 101 with access to memory storage. When executing stored computer-executable process steps from memory 104 (or other storage media or remotely downloading the instructions via a network connection), CPU 101 stores and executes the process steps out of RAM 102.

Read only memory (“ROM”) 103 is provided to store invariant instruction sequences such as start-up instruction sequences or basic input/output operating system (BIOS) sequences for operation of input/output devices.

System 100 includes a display device interface 105 that allows data to be displayed on a display device. Network interface 108 allows network connectivity to system 100 including without limitation, connectivity to the world wide web (“WWW”). Computer-executable process steps, according to one aspect of the present invention may be downloaded via network interface 108.

Input/Output interface 106 allows connectivity to I/O devices for example, a mouse and/or keyboard. Other interface 107 may be used for connecting a peripheral device to system 100.

It is noteworthy that the present invention is not limited to the FIG. 1 architecture. For example, other embedded systems, notebook or laptop computers, handheld devices, set-top boxes or any other system capable of running computer-executable process steps, as described below, may be used to implement the various aspects of the present invention.

It is also noteworthy that the foregoing architecture has been described to show one example of a system that can be used to run the executable process steps according to the present invention. The foregoing is not intended to limit the present invention. The various blocks may be combined or separated. For example, other I/F 107 module can include various sub-blocks for different devices, for example, printers, scanners etc.

FIG. 2 shows a top level block diagram of the software architecture that is used for executing the process steps of the present invention. Application builder 200 compiles high level language 201 instructions (source code instructions) to an intermediate programming language 202. Examples of high level language are C++, Java, Perl or COBOL etc.

Intermediate language (also referred to herein as “IL”) 202 is designed to be low level enough such that converting to native processor code 203 is fast, yet high level enough such that it is possible to validate programs for stability and correctness. Intermediate language 202 is similar to Microsoft.Net common language runtime (“CLR”) and defines execution behavior. The CLR specification as provided by Microsoft® is incorporated herein by reference in its entirety.

In Intermediate language 202, functions are organized into classes which make it easy to locate and manage code. The capability to call virtual functions simplifies code, and permits greater reusability, by allowing code to be written in a more generic fashion. For example, a protocol can be written that is indifferent to whether it's communicating across a serial port, over the Internet, or to a file.

In one aspect of the present invention, application builder 200 allows programmers to build efficient applications that can run on embedded systems with small memory storage space. A programmer selects an executable (.EXE) application file and the application is converted to a compatible image.

The following describes how application builder may be used by a user:

A user installs a program like, Microsoft Visual Studio® on a computing system, described above with respect to FIG. 1. Application builder 200 is launched on system 100. A device (for example, Lantronix XPORT™) is connected to a network. The user runs a program like Visual Studio, creates a Net program using a language such as C#, Visual Basic, C++, or J#. Using Visual Studio, the user builds program and begins debugging. At the time of debugging, application builder 200 launches a dialog box prompting the user to select a device detected on the network, or the PC as the deployment target. This dialog box sends out a network broadcast, in which devices respond with data indicating identification information. The detected devices, which are determined to be compatible, are presented in a list within the dialog box. If the user selects a particular device, for example, the Xport, then application builder 200 detects the version of the device, specifically the Firmware identifier (a 128-bit ID) and the Hardware identifier (a 2-byte ID).

Application builder 200 contains a directory of firmware images specific to various device models, in the form of “.lxi” files—these lxi files are proprietary which contain the actual firmware image as deployed to the device, in addition to a Link Map, Assembly identifier, Firmware ID, and Hardware ID. The Link Map designates the physical addresses of functions on the device firmware as they correspond to functions in referenced DLLs such as dlls that are part of the .Net Framework. Application builder 200 attempts to find a firmware .lxi file on system 100 with a matching Firmware ID.

Once a firmware match has been established, then application builder 200 checks to see if the user's application (in the form of an .exe file) has already been compiled to run on the firmware, by detecting the presence of an lxi file within the same directory as the application with an Assembly ID that matches that of the .exe file's Assembly ID. If no such lxi file exists or one exists with a different Assembly ID, then application builder 200 generates this file. Application builder 200 generates the application image in several phases: (1) building a list of required functions; (2) compiling each function to native code of the device's processor; (3) patching function addresses; (4) compiling a metadata table; (5) writing an application header.

In one aspect of the present invention, a method and system is provided to minimize code requirements that are especially useful for embedded systems, for example, the Lantronix XPORT™.

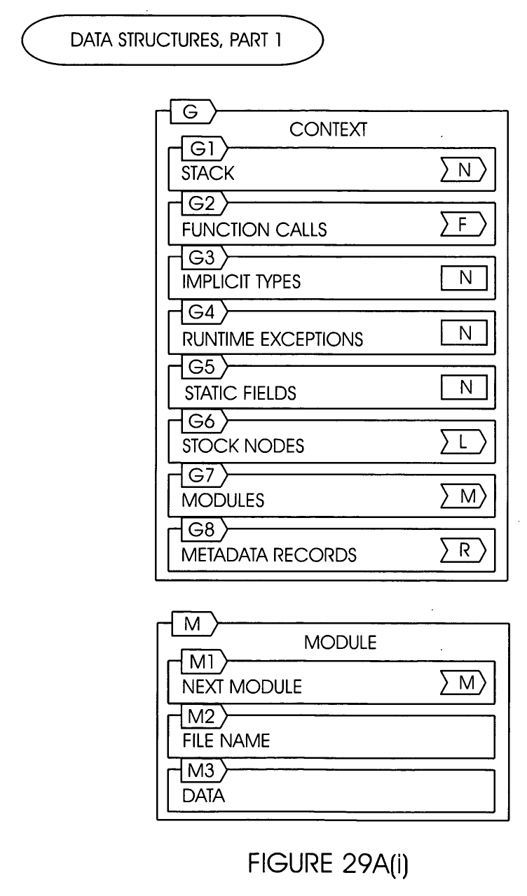

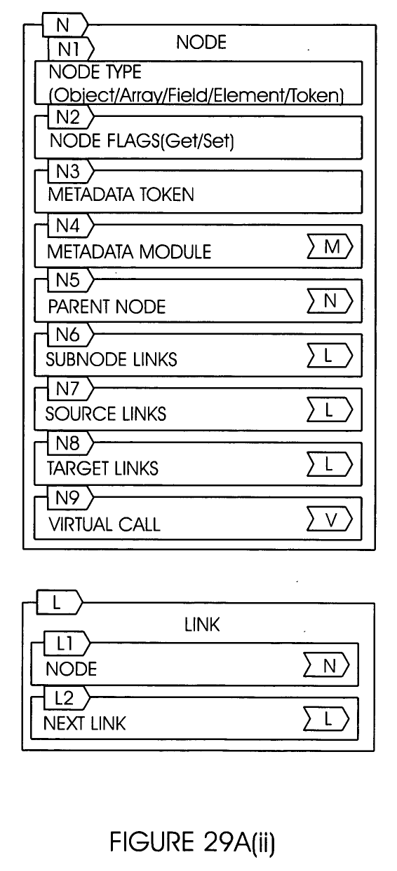

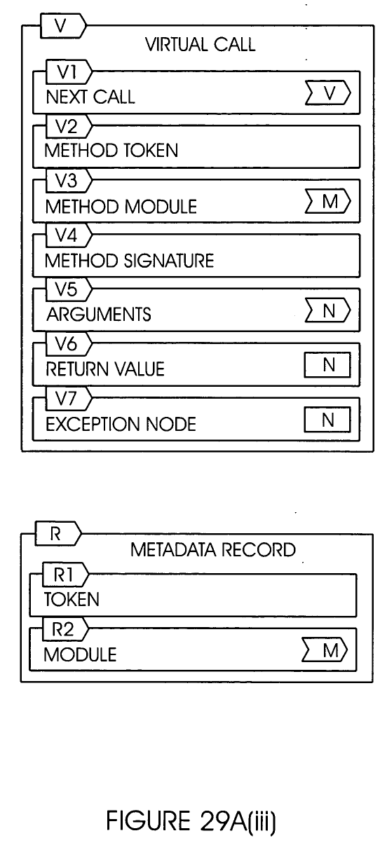

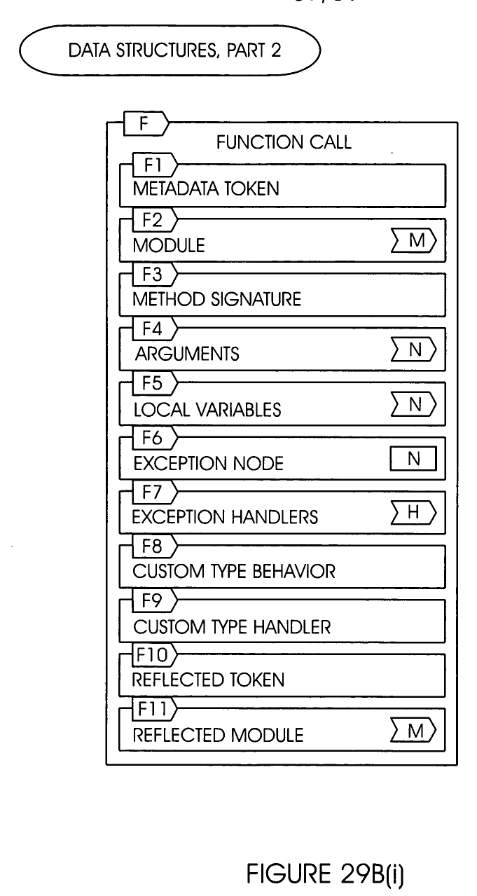

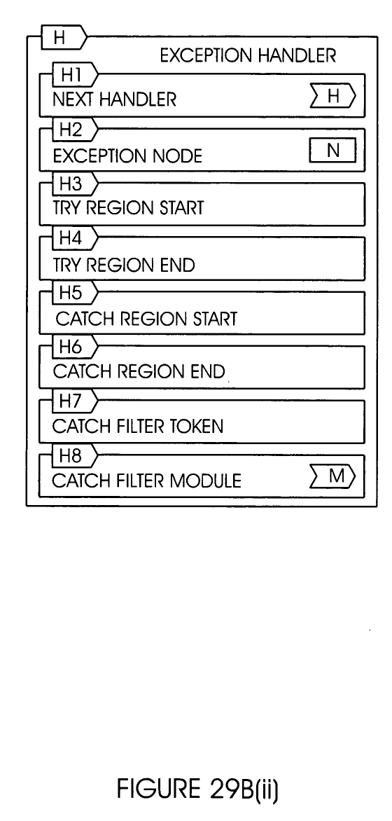

The present invention maintains a network of data structures that are created and manipulated. FIGS. 29A and 29B shows a block diagram of various data structures, according to one aspect of the present invention. The following provides a description of the plural data structures with respect to FIGS. 29A and 29B.

Context Structure [G]:

FIG. 29A shows Context structure [G] that holds information about the overall process.

The Stack [G1] is an array of Nodes [N] that is used for processing each function. The state of this array varies according to the particular position within a function.

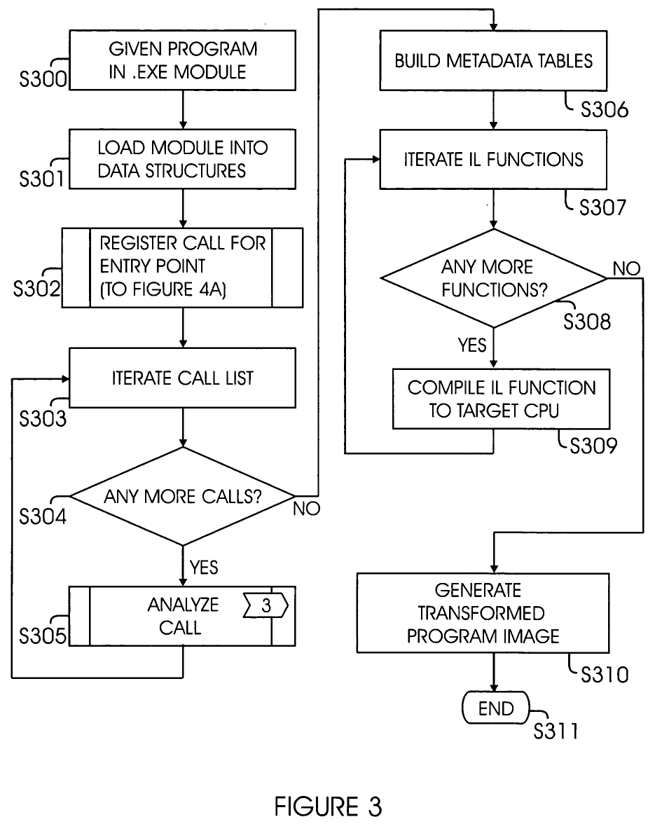

The Function Calls list [G2] is an array of Function Calls [F], where each function call represents a particular call to a function. This list is initialized with the main entry point [FIG. 3] and is appended with each function call [FIG. 27].

The Implicit Types node [G3] is a node [N] consisting of source nodes [N7] that are not explicitly tracked, and are assumed to exist at any virtual function call. A preferred implementation includes the String type in this list. Adding types to this list may decrease the overall processing time at the expense of including extra functions that may not be used. This node is used when evaluating virtual function resolution [FIG. 9, S903-S908]

The Runtime Exceptions node [G4] is a node [N] consisting of source nodes [N7] that specify each possible exception that the underlying runtime execution environment may throw at any instruction. Examples of such exception types include OutOfMemoryException, NullReferenceException, DivideByZeroException, InvalidCastException, IndexOutOfRangeException, and ArrayTypeMismatchException. This node is used when evaluating exception handlers [FIG. 27, S2705].

The Static Fields node [G5] is a node [N] consisting of sub nodes [N6] that specify each static field in use. For each sub node, the node type [N1] is marked “Field”, the module [N4] represents the module [M] containing the field, and the metadata token [N3] represents the specific field within the module [N4]. This node is used when evaluating Load Static Field [FIG. 16] and Store Static Field [FIG. 15] instructions.

The Stock Nodes list [G6] is a linked list [L] of nodes [N] representing commonly used node types. It consists of nodes representing metadata tokens (from Load Token instruction [FIG. 17]) and boxed types (from Box instruction [FIG. 22]). It is used for efficiency such that commonly referenced “Types” link to the same node, rather than creating new nodes in each occurrence.

The Modules list [G7] is a list of referenced modules [M]. The module of the main application is always added to this list, after registering the main entry point function [FIG. 3, S302]. In the process of evaluating functions, every time a function call is made to a function in an external module, or a type is referenced or inherited from an external module, then that external module is added to the list.

The Metadata record list [G8] is an array of referenced metadata rows [R]. Each row describes a particular metadata record from a particular module that is to be included with the resulting program image.

Module Structure [M]:

The Module structure [M] represents a logical organization of program instructions and metadata. For typical implementations, a module directly corresponds to a DLL or EXE file.

The Next Module reference [M1] is a link to the next module in the list. The File Name [M2] is a string representation that locates the data for the module. The Data pointer [M3] is the loaded binary image of the module.

Node Structure [N]:

The Node structure [N] represents a particular type constraint. The Node Type [N1] designates the type of node, which is one of the following: Object, Array, Field, Element, or Token, or None. Object is an object instance, Array is in array instance, Field is a field within an object, Element is an array element within an array, Token is a metadata token of an object, and None is used for aggregating nodes such as arguments and local variables.

The Node Flags [N2] is used for Field and Element nodes, to designate whether the field or element is Loaded, Stored, or both at a particular position of the node.

The Metadata Token [N3] represents the specific metadata table and row within the Metadata Module [N4], such as a particular type, field, or method. The Metadata Module [N4] represents the module [M] containing the metadata token [N3].

The Parent node [N5] is the node containing a node, if any. Any parent node includes this node in its list of sub nodes [N6]. The Subnode list [N6] is a linked list [L] of sub nodes. Sub nodes represent nested items, such as fields within an object, elements within an array, or the metadata token of an object.

The Source list [N7] is a linked list [L] of source nodes. Source nodes represent nodes that affect this node. For example, setting an object reference B equal to A would add A to the list of source nodes of B, and add B to the list of target nodes of A.

The Target list [N8] is a linked list [L] of target nodes. Target nodes represent nodes that are affected by this node. For example, setting an object reference B equal to A would add A to the list of source nodes of B, and add B to the list of target nodes of A.

The Virtual Call list [N9] is a list of virtual call structures [V]. This represents a list of virtual function calls that are affected by the type of this node [N3, N4] and source nodes [N7]. For nodes that are passed as the “this” parameter to a virtual function, the list is appended for each declared virtual function using this node.

Link Structure [L]:

The Link structure [L] represents a linked list of nodes. Alternative implementations may use other mechanisms to represent collections of items; a linked list is used in this description for clarity. The Node [L1] references a particular node. The Next Link [L2] references the next item of the linked list.

Virtual Call Structure [V]:

The Virtual Call structure [V] represents a virtual function call at a particular instruction. Linked lists of these structures are stored on nodes [N9]. The Next Call [V1] references the next virtual call of the linked list. The Method Token [V2] represents the specific metadata method index of the virtual function call. The Method Module [V3] represents the module [M] containing the method token [V2]. The Method Signature [V4] is a cached representation of the argument types, obtained from the metadata of the module [M3]. The Arguments list [V5] is an array of nodes [N] for each argument, including any “this” pointer. The index of the array corresponds to the index of the argument. The Return Value node [V6] is a node [N] representing the return value for the virtual call. If the particular function signature does not have a return value, then the return value node isn't used. The Exception node [V7] is a node [N] used to hold exceptions that may be thrown from each virtual call target.

Metadata Structure [R]:

The Metadata Record structure [R] is used to describe a particular metadata record from a particular module that is to be included with the resulting program image. The Token [R1] represents the specific metadata record. The Module [R2] represents the module [N] containing the metadata token [R1].

Function Call Structure [F]:

The Function Call structure [F] represents a call to a function. For functions consisting of managed code, there is a one-to-one correspondence between functions used and the function calls in this list; i.e., multiple calls to the same managed function result in a single record. For native functions, there may be a one-to-one, one-per-call, or one-per-token mapping, depending on the native function [2]. The Metadata Token [F1] represents the specific metadata method index of the function call. The Module [F2] represents the module [M] containing the method token [F1]. The Method Signature [F3] is a cached representation of the argument types, obtained from the metadata of the module [M3]. The Arguments list [F4] is an array of nodes [N] for each argument, including any “this” pointer. The index of the array corresponds to the index of the argument. The Local Variables list [F5] is an array of nodes [N] for each local variable. The index of the array corresponds to the index of the local variable.

The Exception node [F6] is a node [N] used to hold exceptions that may be thrown from the function or other functions called by this function. The throw instruction [FIG. 25] adds items to this list. Additionally, each native function has a declared list of possible exception types which are added to this list upon registration of the native function [FIG. 27]. Each possible exception type is represented as a source node [N7] of this Exception node. The Exception Handler list [F7] represents the list of exception handlers for the function. The Custom Type Behavior [F8] is used for native functions to indicate whether the type constraint behavior of the native function is Fixed, Unique, or Reflective. Fixed behavior means the native function will affect the type constraint graph the same way regardless of existing type graph state. Unique behavior means the native function could affect the type constraint graph differently based the existing type graph state. Reflective means the native function will affect the type constraint graph in a specific way given a specific input parameter. The Custom Type Handler [F9] refers to a specific script that defines the type behavior for a specific native function.

The Reflected Token [F10] is used for function calls where the Custom Type Behavior [F8] is Reflective. The token represents the specific metadata table and row of the token of the “this” pointer passed to other functions. The Reflected Module [F 11] is used for function calls where the Custom Type Behavior [F8] is Reflective. This token represents the module containing the Reflected Token [F10].

Exception Handler Structure [H]:

The Exception Handler structure [H] holds information about an exception handler within a managed function. The Next Handler [H1] is a link to the next exception handler of the linked list. The Exception Node [H2] is a node [N] that serves as the target of all exceptions that may be thrown within the try region [H3, H4]. The Try Region Start [H3] is the offset of the first instruction within the protected region. Any exceptions thrown within this region are candidates to be caught by the Catch region [H5, H6]. The Try Region End [H4] is the offset of the last instruction within the protected region. The Catch Region Start [H5] is the offset of the first instruction within the catch handler. The Catch Region End [H6] is the offset of the last instruction within the catch handler. The Catch Filter Token [H7] is the metadata token representing the specific exception type caught by the exception handler. The Catch Filter Module [H8] represents the module [M] containing the Catch Filter Token [H7].

It is noteworthy that the foregoing illustration and description of data structures is not intended to limit the present invention. Other layouts may be used in practice depending on the specific MRTE, class libraries used for implementation of the process, and other information that may be tracked. This specific layout of C structures described above is for clarity only.

FIG. 3 shows a flow diagram of the overall process flow diagram for executing a program using a computing system (for example, System 100), according to one aspect of the present invention. The process starts in step S300, when a program is selected (for example, in an .exe format). In step S301, the process loads the executable program into internal data structures and locates the method for the main entry point.

In step S302, a call to the main entry point is registered resulting in a call list [G2, FIG. 29A] containing one entry. Each call is iterated, where each call is analyzed in step S303, until there are no more calls (step S304). Call analysis adds additional calls to the Call List, and calls eventually converge when all functions have been resolved.

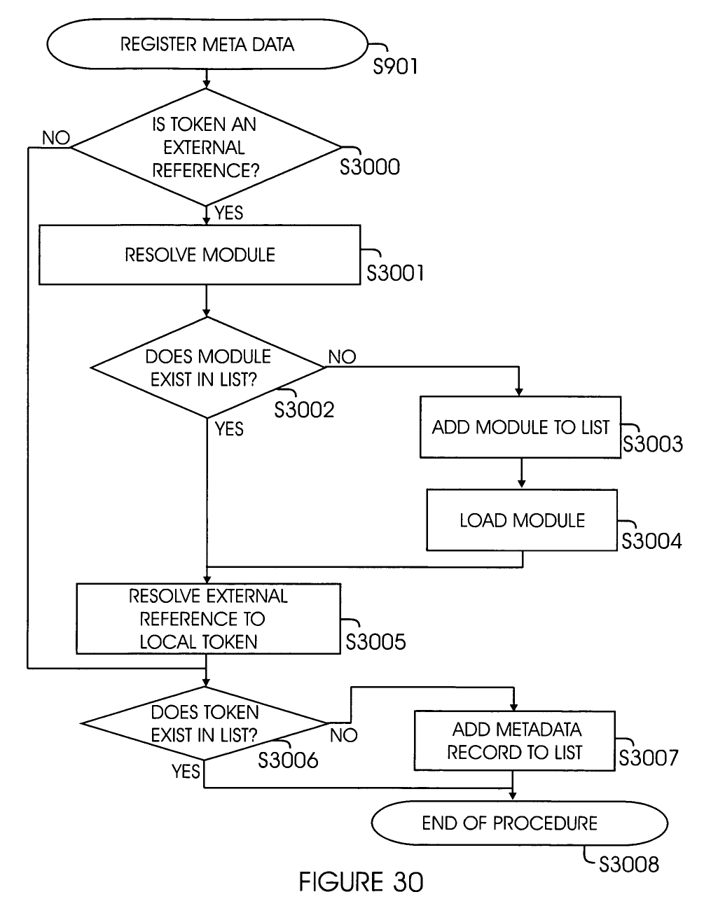

In step S305, the calls are analyzed and once all virtual functions have been resolved, metadata tables are built in step S306 described in detail with respect to FIG. 30. In step S307, all functions are iterated, until the process determines in step S308, that there are no more functions. In step S309, the process compiles IL code 202 to a target processor (native language 203). Thereafter, a binary image is generated in step S310 and the process ends in step S311.

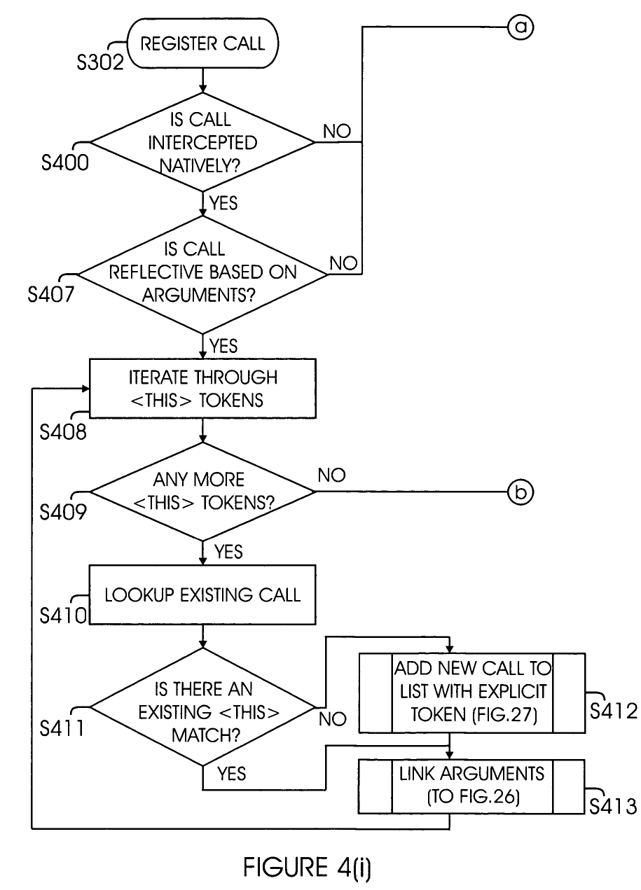

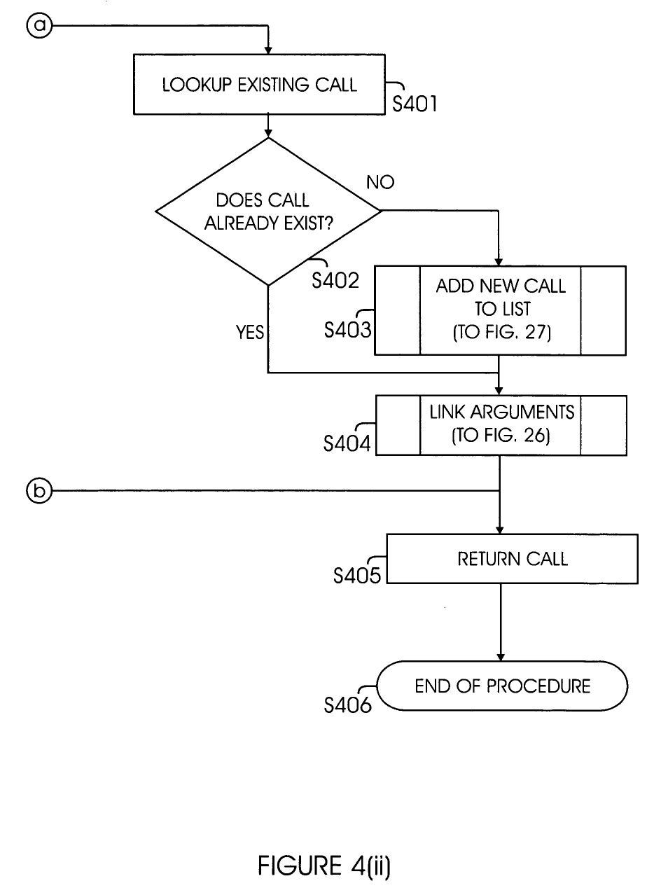

FIG. 4 shows a flow diagram of executable process steps for registering calls, according to one aspect of the present invention. A call list is comprised of every unique call that can take place in a program. While every individual call could be tracked separately, it is more efficient to re-use calls if it can be determined that analyzing a call subsequently would yield the same result. A unique call is defined as a call to a managed function, a static call to a native function, a direct call to a native instance function, a virtual call to a native instance function using a specific “this” value, or a call to a native reflection function using a specific metadata token. Some calls potentially yield divergent virtual function resolutions depending on input parameters, while others always yield the same virtual function resolutions independent of input parameters. Classifying functions by their behavior in this regard typically decreases the total processor time significantly for most programs.

Turning in detail to FIG. 4B, in step S400, the process determines if a call is implemented in managed code or intercepted in native processor code. If the function uses managed code (i.e., a function that has instructions in byte code) then in step S401, the process searches for an existing call to the function. If the call exists, as determined in step S402, the existing record is returned, otherwise, in step S403, the process adds a new call record (Segment F, FIG. 29B) to the list (described with respect to FIG. 27). In step S404, the outgoing arguments of the call are linked to the incoming arguments of the function (described with respect to FIG. 26) and the call record is returned in step S405 and the process ends in step S406.

If the call is intercepted natively in step S400, then in step S407, the process determines if the call is reflective based on arguments. Examples of reflection calls include “Type.GetFields( )”, “Field.GetValue( )”, etc., where the object passed around refers to a specific metadata token, such as a specific Type, a specific Field, etc. An internal list is maintained of all such reflection functions that exhibit this behavior. If the native call is not reflective in step S407, then the process attempts to find an existing call in step S401. If the call is reflective, then in step S408, each metadata token is iterated for “this” argument. A “this” pointer is a keyword that refers to a current instance of a class. For each token found (step S409), the process in step S410 searches for an existing call to the same function with the same metadata token, until all the tokens have been analyzed. If there is no match in step S411, then, the process in step S412, adds a new call record with specific function and metadata token (described with respect to FIG. 27). Otherwise, the existing call record is used to link arguments (described with respect to FIG. 26) in step S412. Steps S410-S412 is conducted until all tokens are exhausted, as shown in step S409.

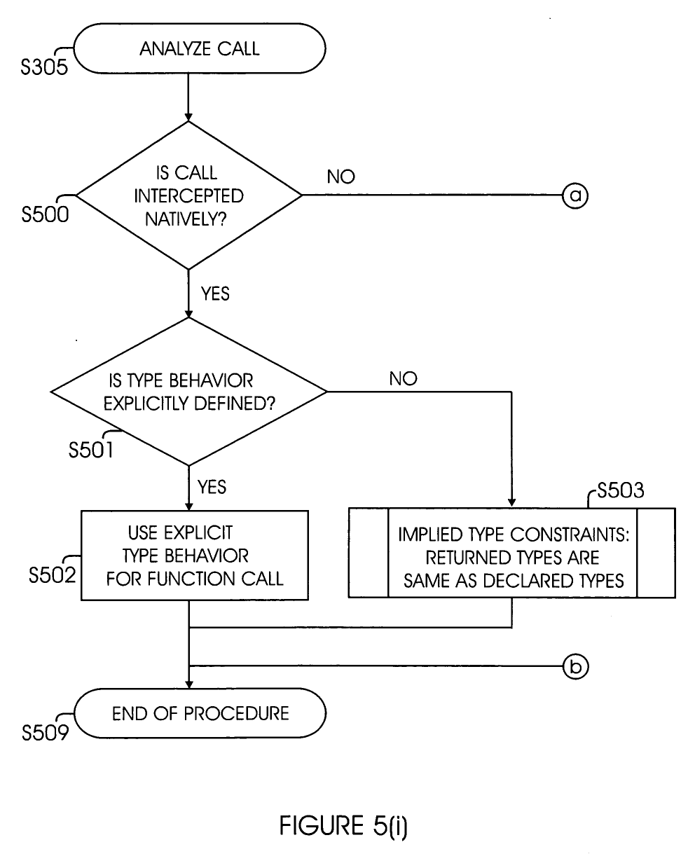

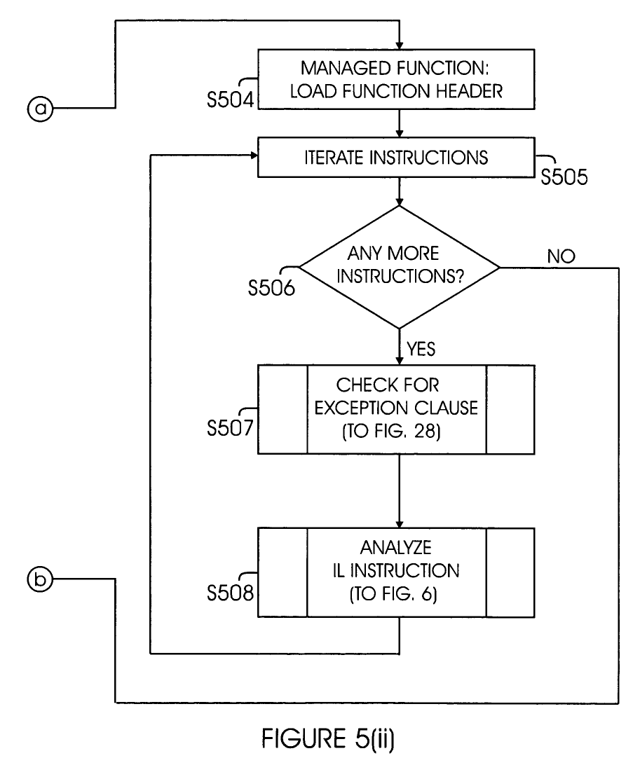

FIG. 5 shows a flow diagram for analyzing calls, according to one aspect of the present invention. The process takes a function and determines behavior types throughout a function.

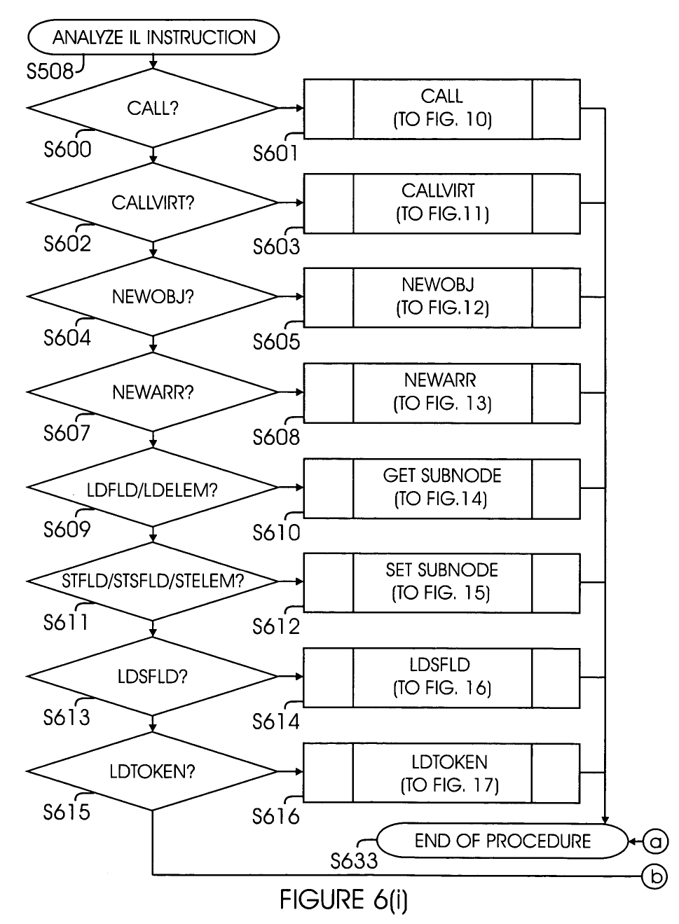

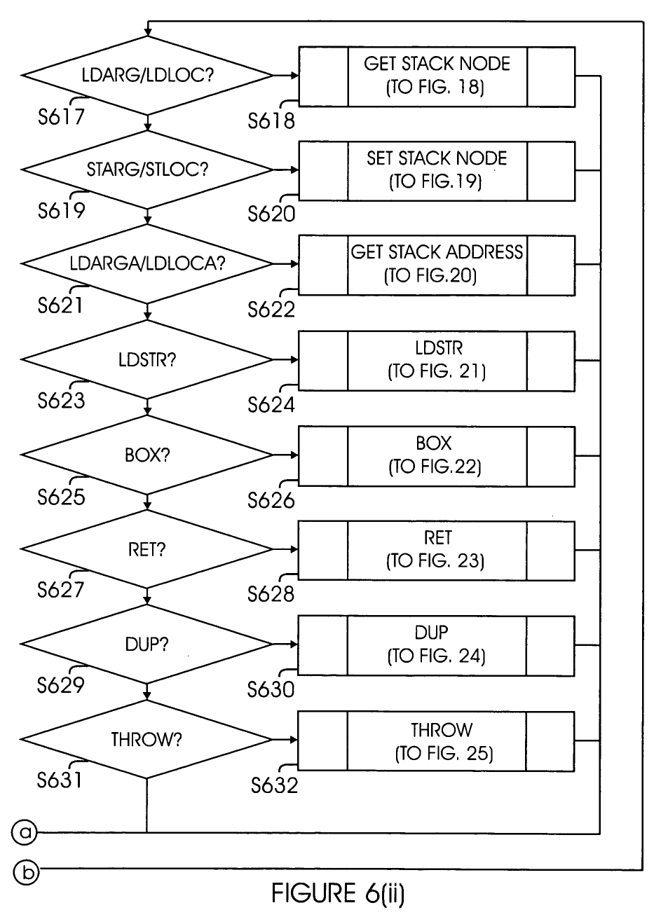

Turning in detail to FIG. 5, in step S500, the process determines if a call is intercepted natively. If not intercepted natively, then in step S504, the process analyzes IL code of the function. The function header is read, which provides local variables types, argument types and exception handling cases. In step S505, each instruction is iterated and checked for exception clause in step S507 (described with respect to FIG. 28). All instructions are analyzed in step S508 (described with respect to FIG. 6), until there are no more instructions (S506).

For native functions (S500), the process searches for a record of the type behavior of the native function. Such records are provided for certain native functions that return different types depending on input parameters such as reflection functions. If a record is found in step S501, then the information in that record is used to define the type behavior in step S502. If no such record is found, then the returned types are assumed to be direct instances of declared types, in step S503, and the process ends in step S509.

When IL code is analyzed, a subset of all possible IL instructions affects the type behavior of a program. A test for each relevant instruction is performed as shown in FIG. 6. The test includes the following:

The “call” instruction in step S600 which is handled by the Call routine in step S601 (described below with respect to FIG. 10); the “callvirt” instruction [S602] which is handled by the Call Virtual routine [S603] (described below with respect to FIG. 11); the “newobj” instruction [S604] which is handled by the New Object routine [S605] (described below with respect to FIG. 12) ;the “newarr” instruction [S607] which is handled by the New Array routine [S608] (described below with respect to FIG. 13); the “ldfld” and “ldelem” instructions [S609] which are handled by the Get Subnode routine [S610] (described below with respect to FIG. 14); the “stfld”, “stsfld”, and “stelem” instructions [S611] which are handled by the Set Subnode routine [S612] (described below with respect to FIG. 15); the “ldsfld” instruction [S613] which is handled by the Load Static Field routine [S614] (described below with respect to FIG. 16); the “ldtoken” instruction [S615] which is handled by the Load Token routine [S616] (described below with respect to FIG. 17); the “ldarg” and “ldloc” instructions [S617] which are handled by the Get Stack Node routine [S618] (described below with respect to FIG. 18); the “starg” and “stloc” instructions [S619] which are handled by the Set Stack Node routine [S620] (described below with respect to FIG. 19); the “Idarga” and “ldloca” instructions [S621] which are handled by the Get Stack Address routine [S622] (described below with respect to FIG. 20);the “ldstr” instruction [S623] which is handled by the Load String routine [S624] (described below with respect to FIG. 21); the “box” instruction [S625] which is handled by the Box routine [S626] (described below with respect to FIG. 22); the “ret” instruction [S627] which is handled by the Return routine [S628] (described below with respect to FIG. 23); the “dup” instruction [S629], which is handled by the Duplicate routine [S630] (described below with respect to FIG. 24); and the “throw” instruction [S631], which is handled by the Throw routine [S632] (described below with respect to FIG. 25).

All other IL instructions are ignored for type analysis, although the stack is adjusted for all instructions.

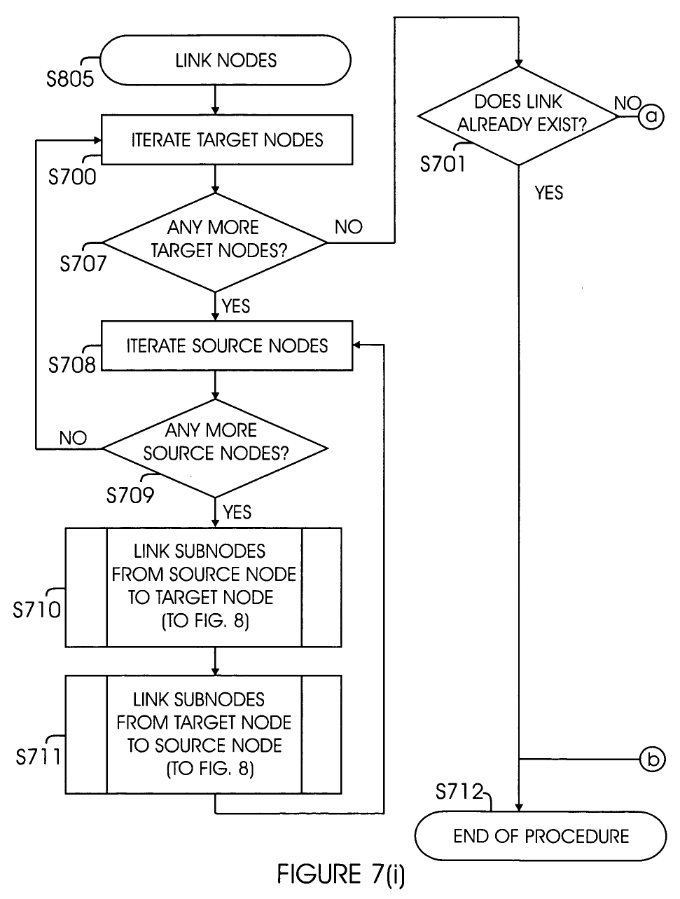

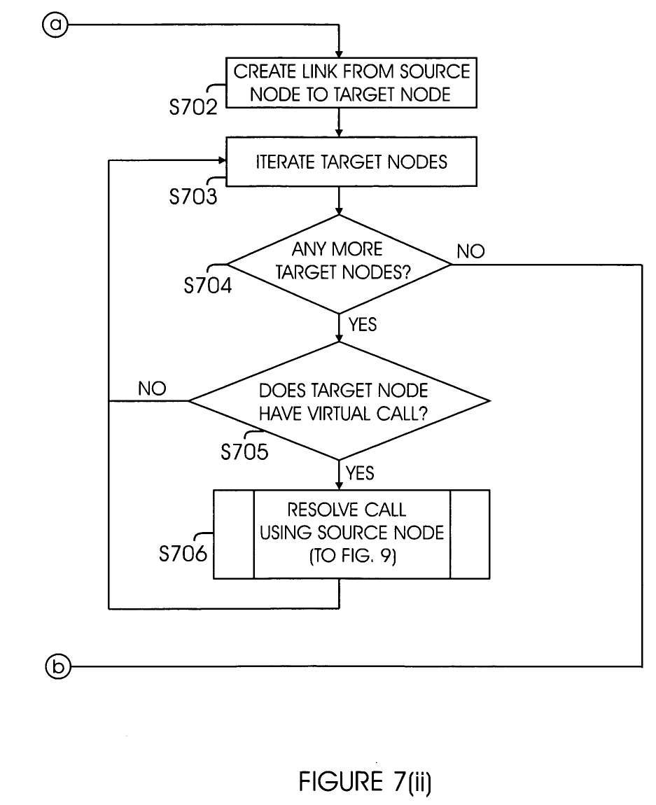

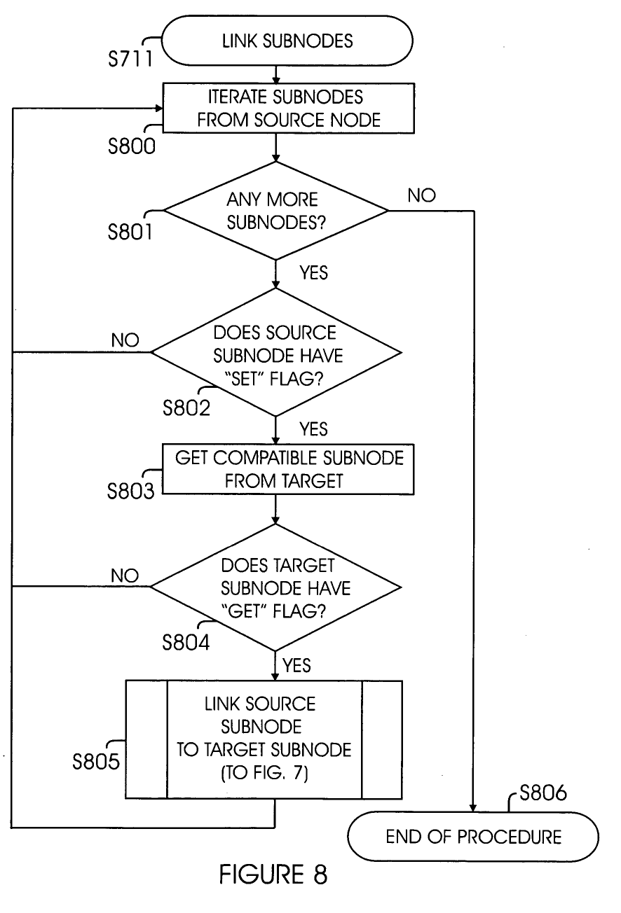

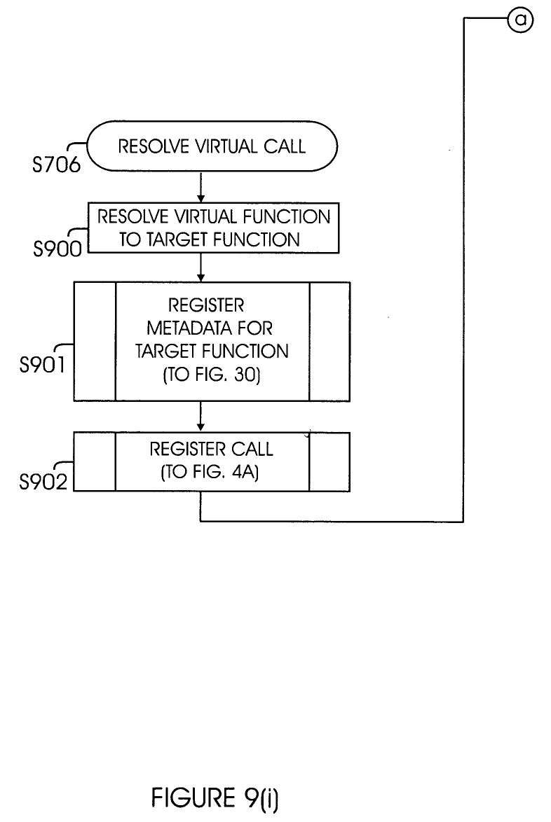

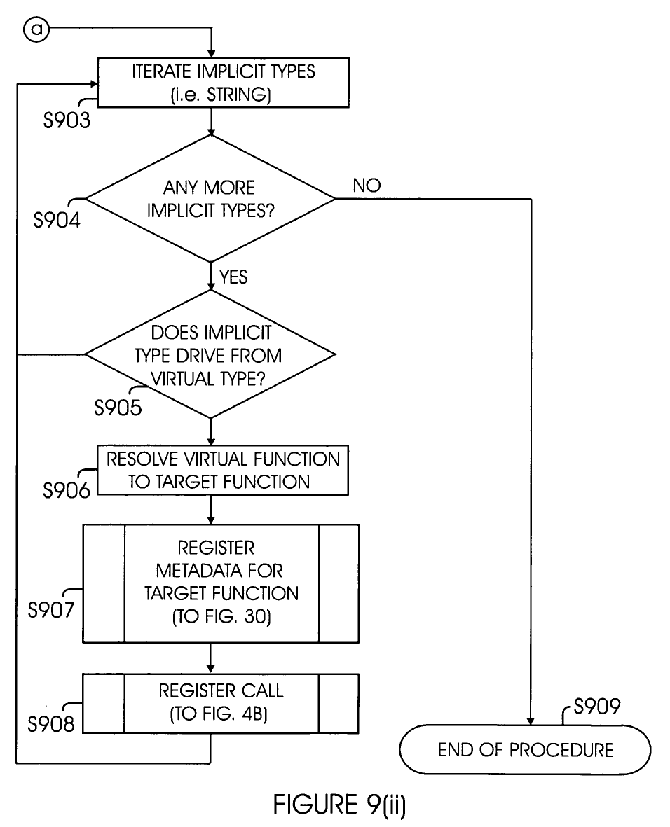

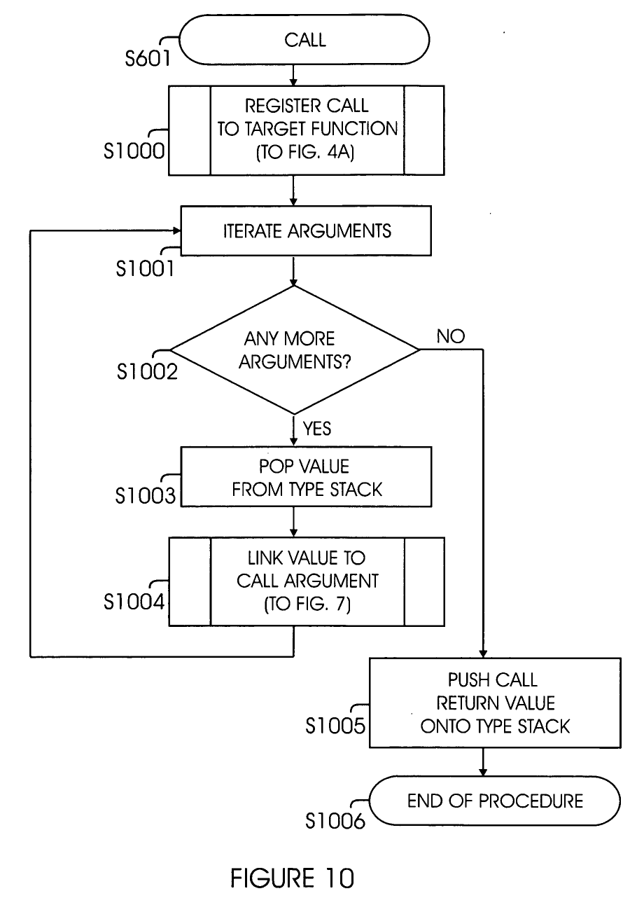

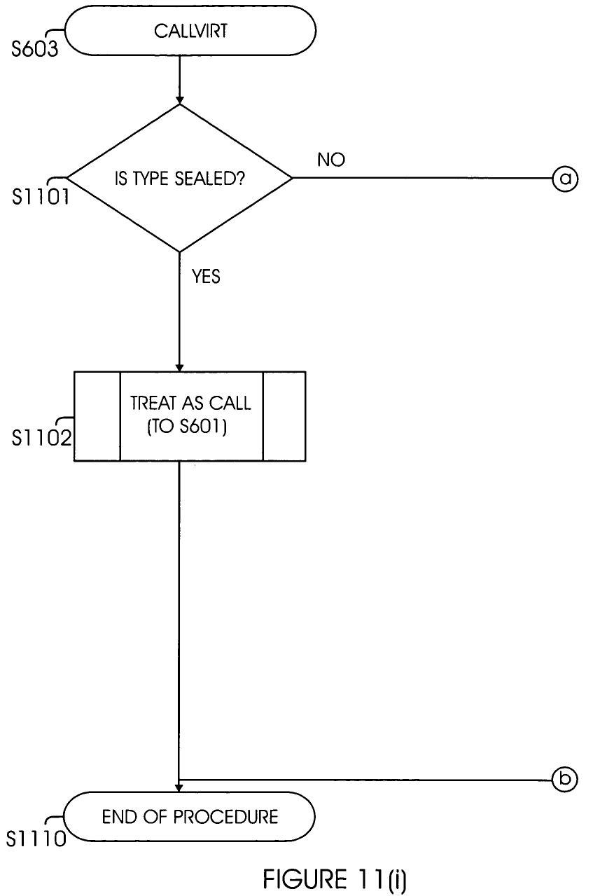

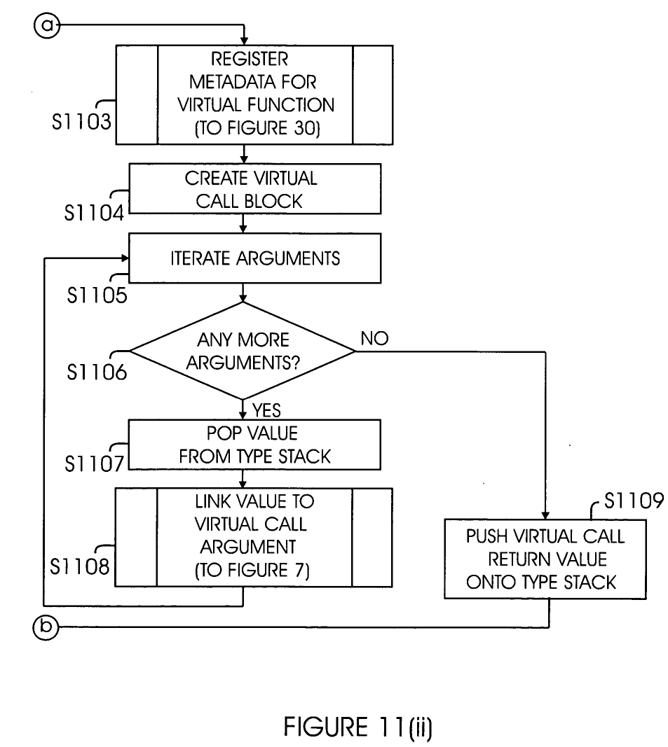

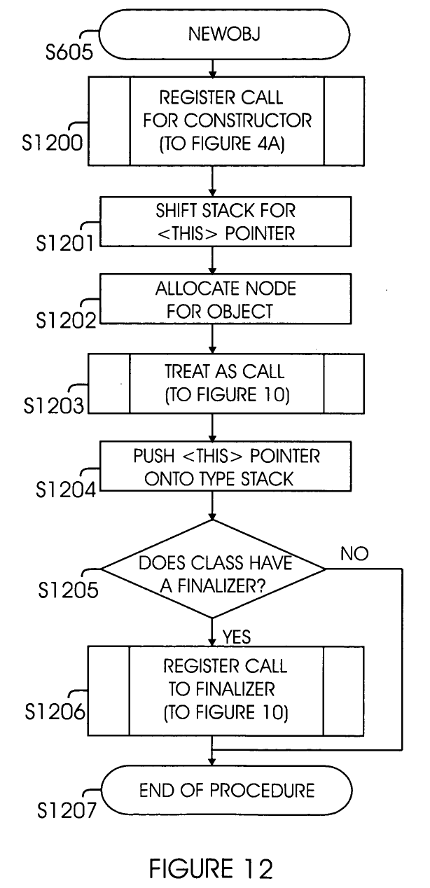

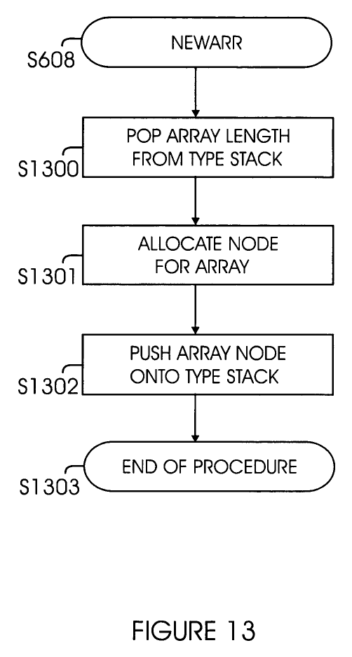

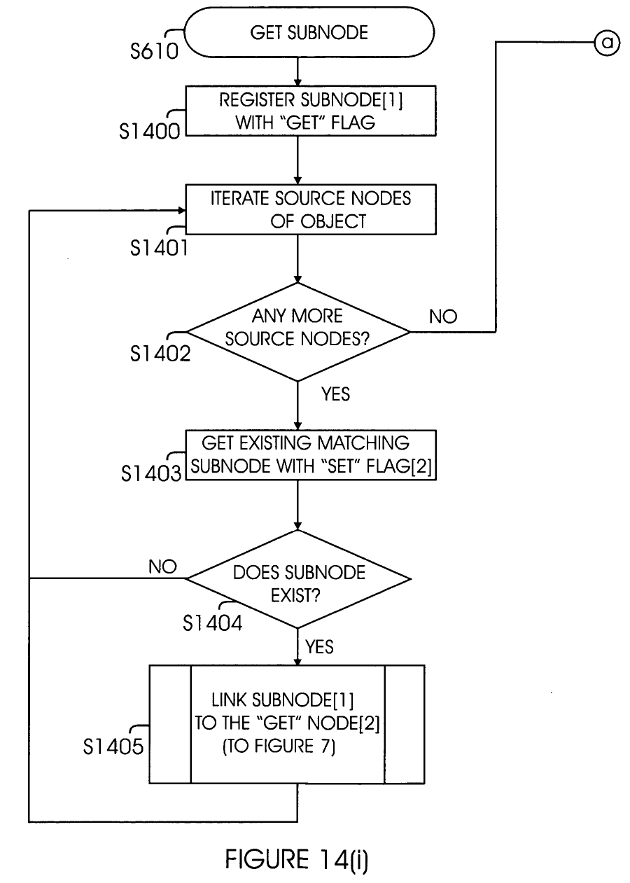

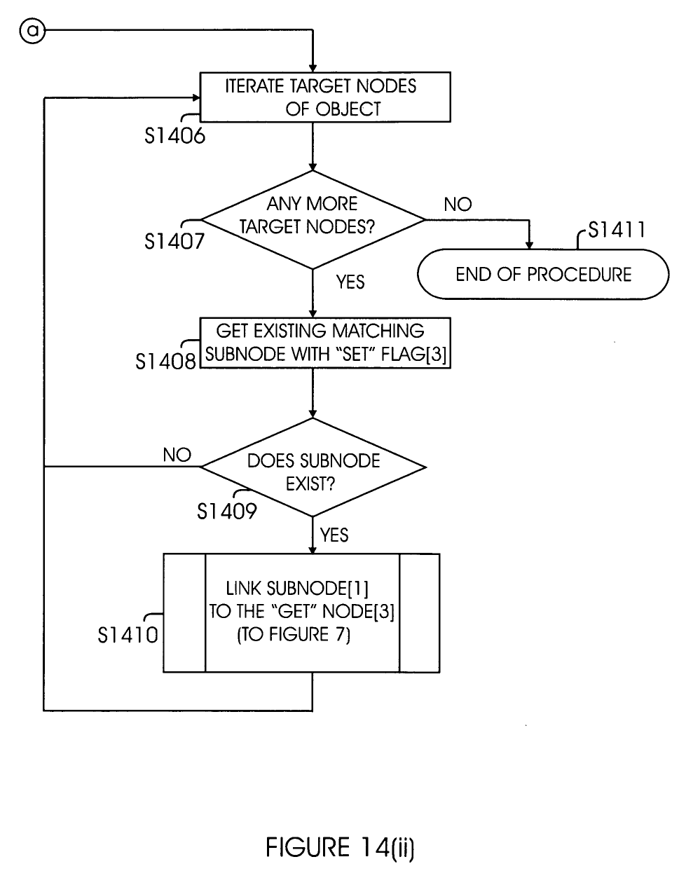

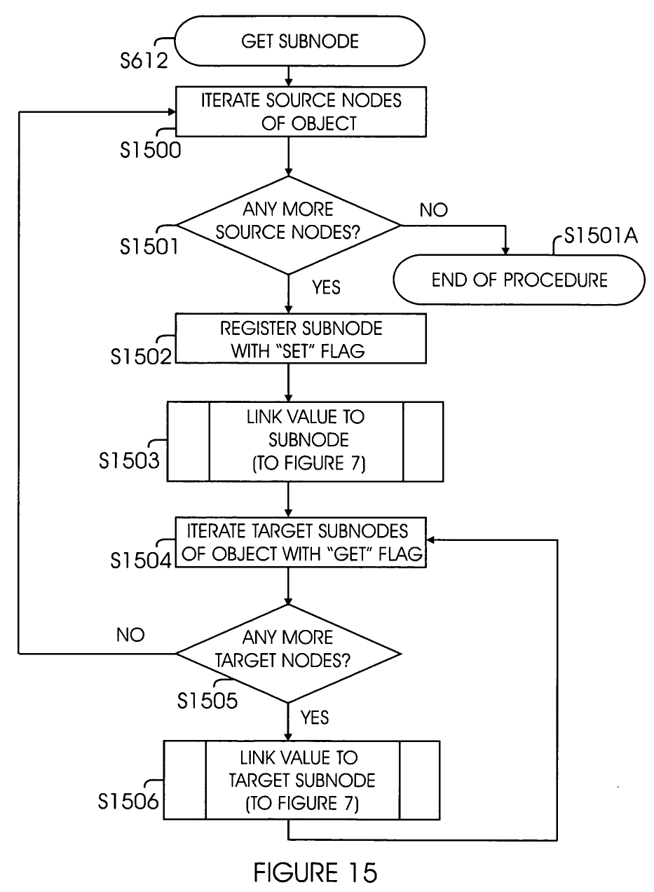

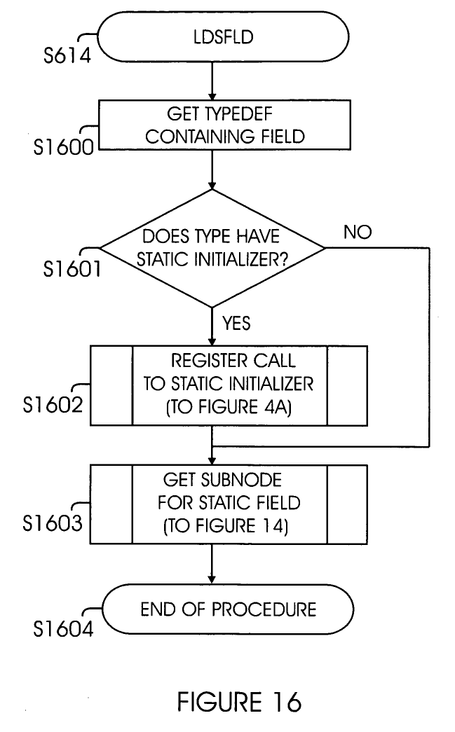

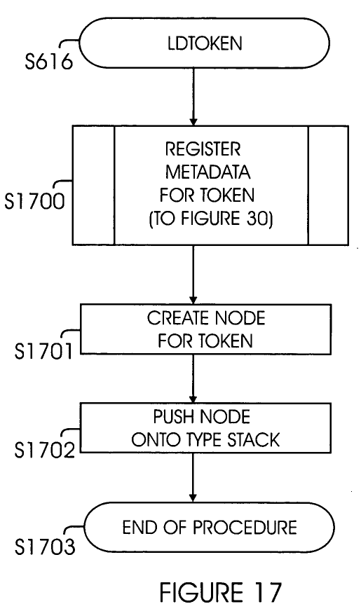

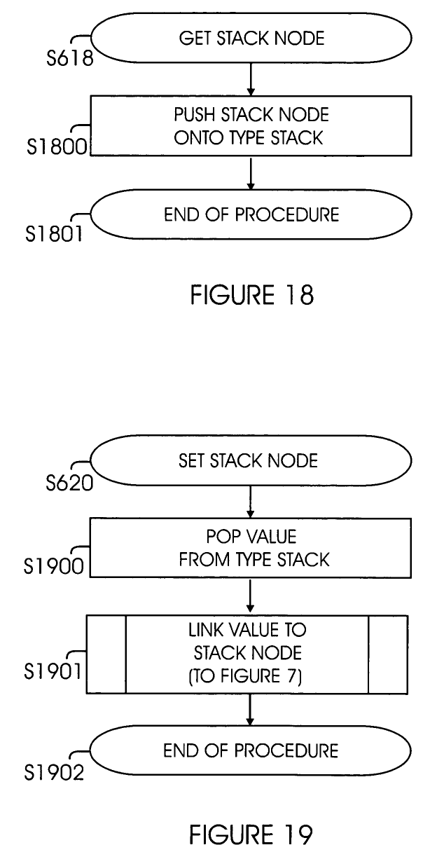

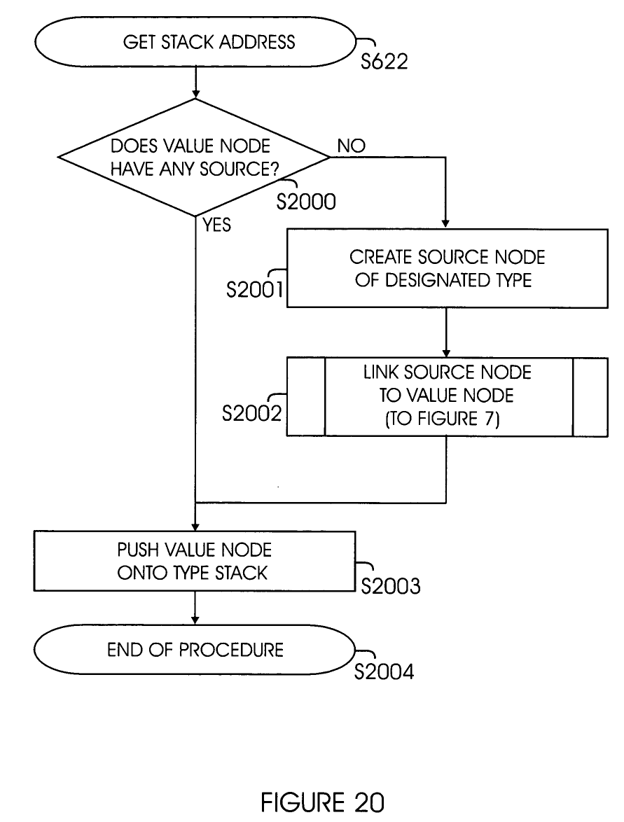

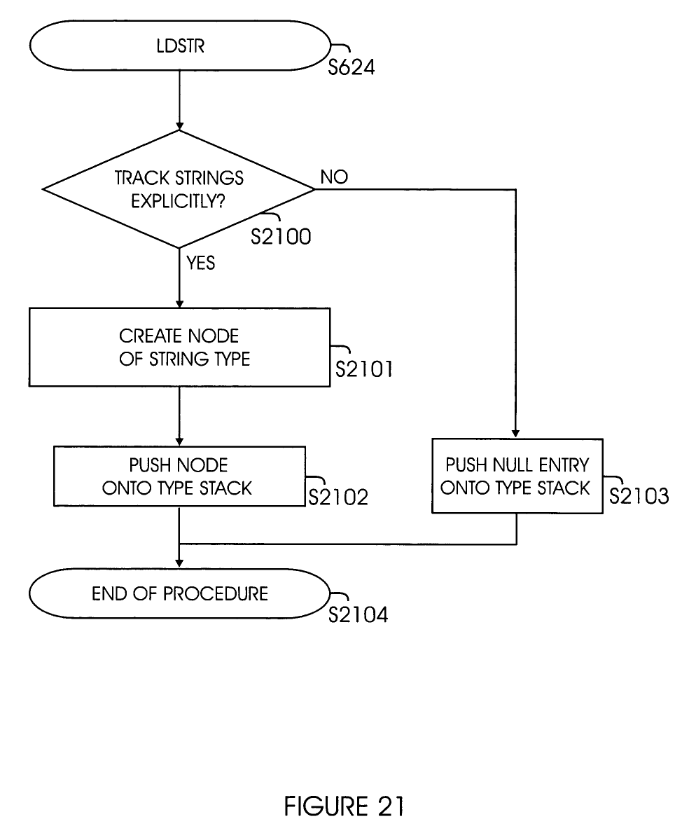

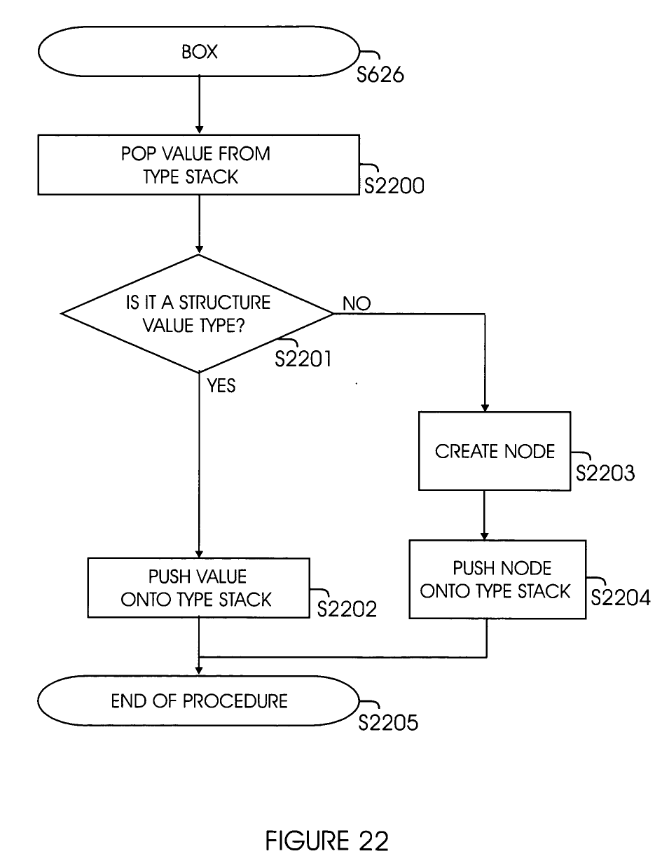

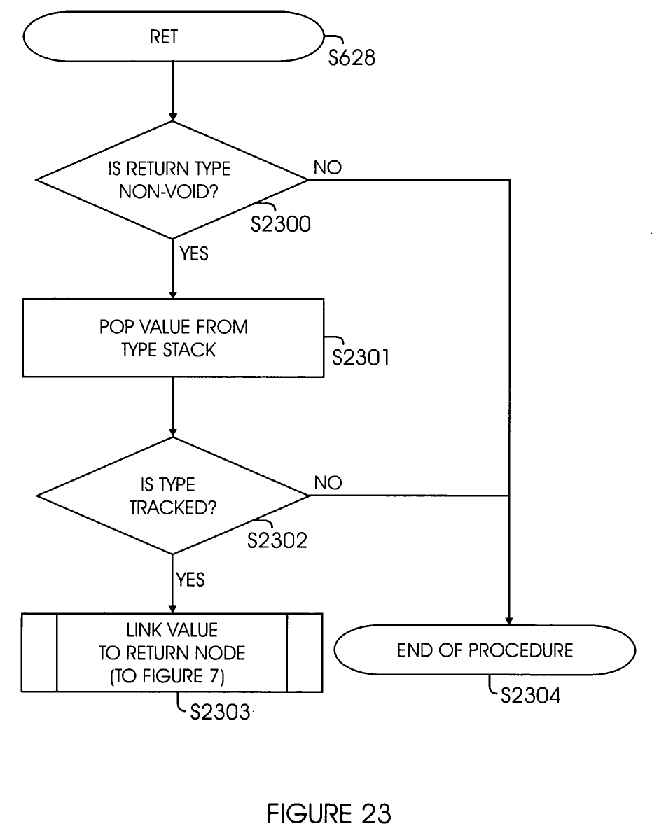

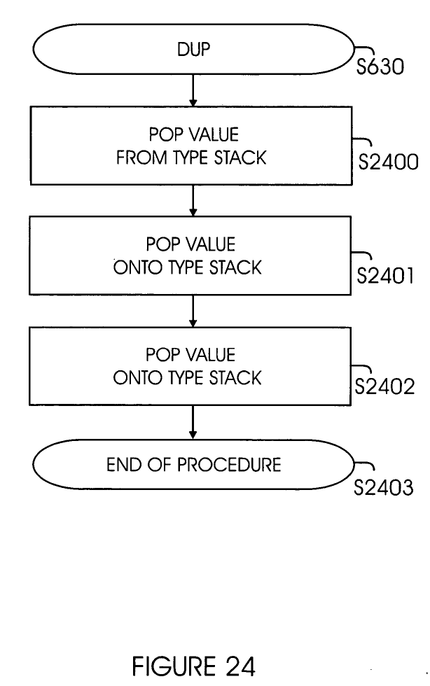

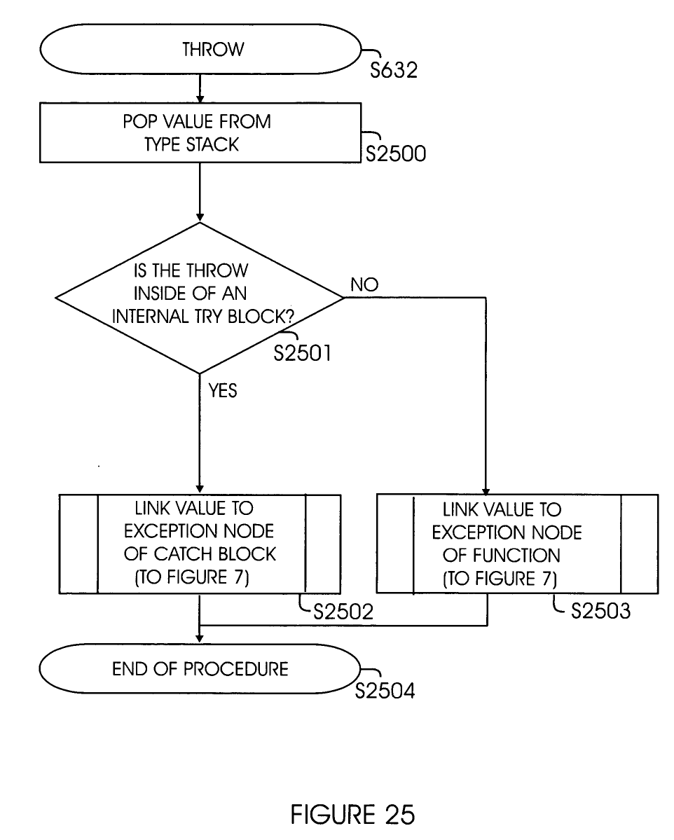

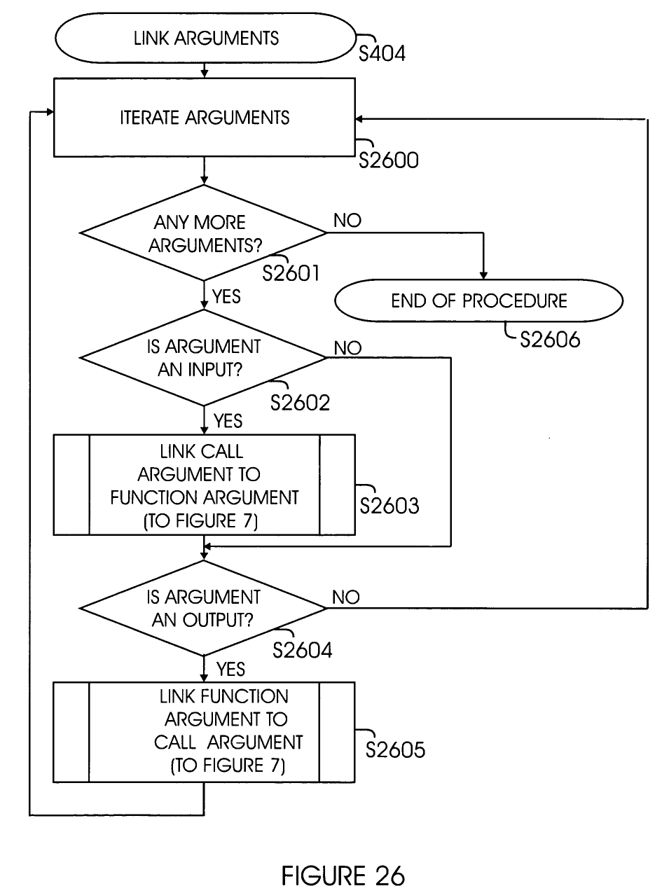

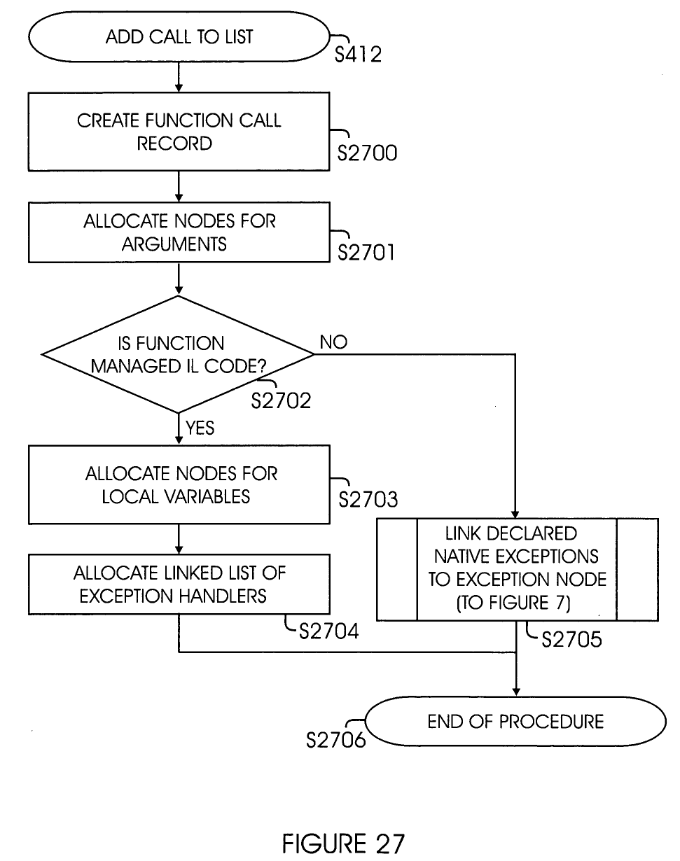

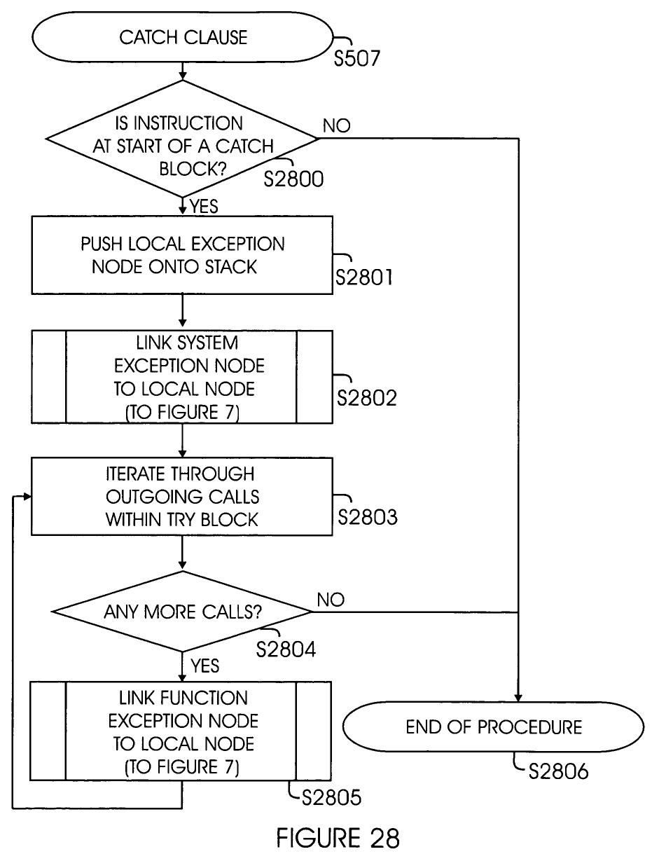

FIG. 7 shows a flow diagram for linking nodes, according to one aspect of the present invention. The process of linking nodes is used to designate a source-to-target relationship between values in a program. A link between two nodes indicates that the value of the first node propagates to the value of the second node. Though the link itself is directional, any sub-nodes (such as fields of an object or elements of an array) of each node may propagate in either direction. For example, if an object is passed as an input argument to another function, the object itself passes in a single direction, though a field of that object could be set on either end, in which it would impact places where that field is retrieved on either side of the link.

In order to link sub-nodes in both directions, each target node is iterated [S700], and each source node is iterated [S708], until there are no more source nodes [S709] and target nodes [S707]. Sub-nodes of each source node are linked to sub-nodes of each target node [S710, (also described below with respect to FIG. 10)] and vice-versa [S711, (also described below with respect to FIG. 10)].

The process checks if a link between the source and target node already exists [S701]. If yes, then the subroutine completes [S712]. Otherwise, a link [L, FIG. 29A] is created [S702], and each target node is iterated [S703] until there are no more target nodes [S704]. If a target node has a virtual call associated with it [S705], then the virtual call is resolved using the source node [S706]. The process ends in step S712.

FIG. 8 shows a flow diagram for linking sub-nodes, according to one aspect of the present invention. The process of linking sub-nodes involves creating links between where a value is set in an object, array, or metadata token, and where a value is retrieved. The sub-nodes of a source node are iterated [S800] until there are no more subnodes [S801]. For each source subnode, if the “set” flag is false [S802], the process proceeds to the next subnode [S800]. Otherwise, if the “set” flag is true, then the process attempts to find a compatible subnode on the target [S803]. If such a subnode exists and if the “get” flag is true [S804], then the source subnode is linked to the target subnode [S805]. The process ends in step S806.

FIG. 9 shows a flow diagram for resolving virtual function calls, according to one aspect of the present invention. Virtual function calls are resolved when new information is provided that potentially impacts the type of the “this” parameter. Given a virtual function and the type of the “this” parameter, the target function is resolved [S900], and metadata is recorded for that target function [S901 (described below with respect to FIG. 30)]. A call to the target function is then registered in step S902.

In addition to the explicit type, there may be other types not specifically tracked for efficiency. For example, it is typically more optimal not to track String types explicitly as they are very common, and the extra time required to track strings is very costly compared to the small benefit of slightly smaller code. These types are referred to as “implicit types”, where are defined in advance [G3, FIG. 29A]. To compensate for such optimizations, it is assumed that any virtual function call could take a parameter of an implicit type if the implicit type derives from the type containing the virtual function.

Each implicit type is iterated [S903] until there are no more implicit types [S904] and the process ends in step S909. If the implicit type derives from the virtual type [S905], then the target function is resolved [S906]. The metadata is recorded for the target function [S907] and a call is registered to that function [S908 (also described above with respect to FIG. 4B)]. The process ends in step S909.

FIG. 10 shows a flow diagram of process steps for handling direct calls to functions. The Call instruction is used for direct calls to functions. First, the target function is registered [S 1000]. Then each argument is iterated [S 1001] until there are no more arguments [S1002]. For each argument, the value node is popped (or initialized) from the type stack [S1003], and the value node is linked to argument node of the target function [S1004 (described above with respect to FIG. 7)]. If the target function returns a value, then the return value node of the target function is pushed onto the type stack [S1005]. Thereafter, the process ends in step S1006.

FIG. 11 shows a flow diagram for handling virtual functional calls, according to one aspect of the present invention. The “Call Virtual” instruction is used for virtual function calls. If the type containing the virtual function is marked as sealed [S1101], then the virtual call is treated as a direct call [S1102]. Otherwise, metadata is recorded for the virtual function [S1103 (also described below with respect to FIG. 30)] and a virtual call block record [V, FIG. 29A] is created [S1104]. Each argument of the call is iterated [S1105] until there are no more arguments [S1106]. For each argument, the value node is popped from the type stack [S107] and linked to the corresponding argument node of the virtual call record [S1108, [described above with respect to FIG. 7]]. When there are no more arguments [S1106], if the method referenced by the virtual call contains a return value, then the return value node of the virtual call block is pushed onto the type stack [S1109]. The process ends in step S1110.

FIG. 12 shows a flow diagram for instantiating objects. The New Object instruction is used for instantiating objects, according to one aspect of the present invention. First the call to the constructor is registered [S1200 (described above with respect to FIG. 4B)]. Then, the type stack [G1, FIG. 29A] is shifted to make room for the “this” pointer [S1201]. A new node [N, FIG. 29A] is allocated for the object and is stored on the type stack [S1202]. The call to the constructor is analyzed [S1203 (described above with respect to FIG. 10)], which pops and links any arguments from the stack. The “this” pointer is then pushed back onto the type stack [S1204]. If the class has a “finalize” function [S1205], then that “finalize” function is automatically included by registering it [S1206 (described above with respect to FIG. 10)]. The process ends in step S1207.

FIG. 13 shows a flow diagram for using a “New Array” instruction for creating single-dimension zero-based arrays, according to one aspect of the present invention. In step S1300, the last slot on a type stack which holds the array length is initialized. In step S1301, a node [N, FIG. 29A] is allocated for the array and then in step S1302, the array is pushed onto the type stack. The process ends in step S1303.

FIG. 14 shows a flow diagram for using the “Get Subnode” routine, according to one aspect of the present invention. The Get Subnode routine is used by instructions such as “Load Field” and “Load Array Element” and marks a subnode retrieval operation.

In step S1400, a corresponding subnode of an object (1) is registered with the “get” flag. In step S1401, each source node is iterated until there are no more source nodes, as shown in step S1402. For each source node, the process in step S1403, searches for a matching subnode (2) with the “set” flag set. If such a subnode exists (step S1404), the original registered subnode (1) is linked to the matching subnode (2) [S1405 (described above with respect to FIG. 7)]. This process is repeated for the target nodes of the object, where each target node is iterated in step S1406 until there are no more target nodes [S1407 and S1411 when the process ends]. For each target node, the process in step S1408 searches for a matching subnode (3) with the “set” flag set. If such a subnode exists [S1409], the original registered subnode (1) is linked to the matching subnode (3) [S1410 (described above with respect to FIG. 7)].

FIG. 15 shows a flow diagram for using the Set Subnode instruction, according to one aspect of the present invention. The Set Subnode routine is used by instructions such as “Store Field”, “Store Static Field”, and “Store Array Element”. The source nodes of the object are iterated in step S1500 until there are no more source nodes as shown in step S1501 and S1501A. In step 502, each source node is registered with the “set” flag. In step S1503, the value node is linked to the sub node (described above with respect to FIG. 7). Then in step S1505, each target subnode of the object with a “get” flag is iterated until there are no more target subnodes [S1505]. In step S1506, for each target subnode, the value node is linked to the target subnode (described above with respect to FIG. 7).

FIG. 16 shows a flow diagram for using the “Load Static Field” (“LDSFLD”) instruction, according to one aspect of the present invention. The “Load Static Field” instruction is similar to the “Load Field” instruction, except that the retrieval of a static field implies that the static field is initialized, which is typically done in a static initializer function. In step S1600, the type is retrieved that contains the referenced static field. If the type contains a static initializer function [S1601], then in step S1602, a call is registered to the static initializer (described above with respect to FIG. 4B). Then in step S1603, the procedure falls back on default behavior for field retrieval, where the subnode is retrieved for the static field (described above with respect to FIG. 14). Unlike instance fields where a node for the object instance is provided, in the case of static fields, a global node is used to contain static field information. The process ends in step S1604.

FIG. 17 shows a flow diagram for using the Load Token instruction, according to one aspect of the present invention. The “Load Token” instruction is used for designating types or other metadata information. In step S1700, metadata for a token is registered (described below with respect to FIG. 30), a node [N, FIG. 29A] is created for the token in step S1701, and the node is pushed onto the type stack in step S1702. The process ends in step S1703.

FIG. 18 shows a flow diagram for using the ‘Get Stack Node” routine, according to one aspect of the present invention. The “Get Stack Node” routine is used for retrieving arguments or local variables of a function. As each function call record [F, FIG. 29B] carries its arguments and local variables with it, the specified argument or local variable is simply pushed onto the type stack, in step S1800. Thereafter the procedure ends in step S1801.

FIG. 19 shows a flow diagram for using the ‘Set Stack Node” routine, according to one aspect of the present invention. The “Set Stack Node” routine is used for storing arguments or local variables of a function. In step S1900, the value node is initialized from the type stack and then in step S1901, the value node linked to the designated argument or local variable stack node(described above with respect to FIG. 7). The procedure ends in step S1902.

FIG. 20 shows a flow diagram for using the ‘Get Stack Address” routine according to one aspect of the present invention. The “Get Stack Address” is used for retrieving addresses of arguments or local variables. It is typically used with value types. As value types are not allocated with the “newobj” instruction, a record may not yet exist that holds information about its type origination. If the value node does not have at least one source [S2000], then in step S2001, a source is created to represent the designated type. In step S2002, the source node is linked to the value node(described above with respect to FIG. 7). The value node is then pushed onto the type stack in step S2003 and the process ends in step S2004.

FIG. 21 shows a flow diagram for using the “Load String” (“LDSTR”) function according to one aspect of the present invention. The “Load String” function is used for putting string literals onto a stack. If optimization is used such that strings are not tracked explicitly [S2100], then in step S2101, the instruction is ignored and a null entry is pushed onto the type stack in step S2103. Otherwise, in step S2101, a node is created for the string and pushed onto the type stack in step S2102. The procedure ends in step S2104

FIG. 22 shows a flow diagram for using the “Box” instruction, according to one aspect of the present invention. The “Box” instruction is used for converting a value type into an object. In step S2200, the value is initialized from the type stack. If the value type is a structure [S2201], then in step S2202, the value node is pushed onto the type stack. If the value type is a simple type or an enumeration, then in step S2203, a node is created and pushed onto the type stack in step S2204. The procedure ends in step S2205.

FIG. 23 shows a flow diagram for using the “Return” (“RET”) instruction, according to one aspect of the present invention. The “Return” instruction is used for returning values from a function. If a function does not have a return value (indicated by a “void” designation), then the routine exits [S2300]. Otherwise, in step S2301, the value is initialized from the type stack. If the type is tracked (it is not contained in the list of implicit types) [S2302], then in step S2303, the value is linked to the return value of the function (described above with respect to FIG. 7). The procedure ends in step S2304

FIG. 24 shows a flow diagram for using the “Duplicate” (‘DUP”) instruction, according to one aspect of the present invention. The “Duplicate” instruction is used to duplicate the last value on the stack. In step S2400, the last value of the stack is initialized, and then pushed onto the Type stack in steps S2401 and S2402. The procedure ends in step S2403.

FIG. 25 shows a flow diagram for using the “Throw” instruction, according to one aspect of the present invention. The “Throw” instruction is used for throwing an exception, in which the last item on the stack is the exception object. The exception object is initialized from the type stack in step S2500. If the location of the throw instruction is within a try region of a current function [S2501], then in step S2502 (described above with respect to FIG. 7), the exception value node is linked to the exception node [H2, FIG. 29B] of any corresponding catch block. Otherwise, in step S2503, the exception value node is linked to the exception node of the current function (described above with respect to FIG. 7). The procedure ends in step S2504

FIG. 26 shows a flow diagram for using the “Link Arguments” routine, according to one aspect of the present invention. The “Link Arguments” routine is used for linking input parameters in the forward direction, output parameters in the reverse direction, and in/out parameters in both directions. Each argument is iterated in step S2600 until there are no more arguments [S2601]. If an argument is an input [S2602], then the source call argument is linked to the target function argument [S2603 (described above with respect to FIG. 7)]. If an argument is an output [S2604], then the target function argument is linked to the source call argument [S2605 (described above with respect to FIG. 7)]. The procedure ends in step S2606.

FIG. 27 shows a flow diagram for using the “Add Call to List” routine, according to one aspect of the present invention. The “Add Call to List” routine creates a new function [F, FIG. 29A] call record and initializes its contents. In step S2700, a new function call record is created and in step S2701, nodes are allocated for any arguments of the function. If the function is managed [S2702], then in step S2703, nodes are allocated for any local variables and in step S2704, a linked list of exception handler records is constructed to hold each exception handler. If the function is native [S2702], then in step S2705 (described above with respect to FIG. 7), the declared thrown exceptions of the native function are linked to the exception node of the function. The procedure ends in step S2706.

FIG. 28 shows a flow diagram for using the “Catch Clause” routine, according to one aspect of the present invention. In step S2800, the “Catch Clause” routine checks if the current instruction is at the beginning of a “catch” handler. If not the case, then the routine exits and the procedure ends in step S2806. If it is at the beginning of a “catch” handler, then in step S2801, the exception node [H2, FIG. 29B] of the catch clause is pushed onto the type stack. As any runtime exception could occur such as OutOfMemoryException or NullReferenceException, the node representing runtime exceptions [G4, FIG. 29A] is linked to the local exception node [S2802]. To catch other exceptions, in step S2803, each outgoing call within the corresponding “try” block is iterated until there are no more calls [S2804]. For each call, the exception node of the call is linked to the local exception node [S2805]. The process ends in step S2806.

FIG. 30 shows a process flow diagram for executing the “Register Metadata” routine. The routine includes a metadata record from a source module into a converted program image. Rather than incorporating entire metadata tables from each referenced module, to conserve space, metadata is aggregated into a single set of tables, only including rows of metadata that is referenced by a specific program.

First, the routine checks if the local token describes a reference table [S3000]. Examples of reference tables include TypeRef, MemberRef, and AssemblyRef. If it's an external reference, the reference module is resolved by its name [S3001]. If the reference module is not in the existing list of modules [S3002][G7, FIG. 29A], then a module record [M, FIG. 29A] is created and added to the list [S3003]. The module is then loaded into memory [S3004] where the binary image is referenced by the Data field [M3, FIG. 29A]. Then, the external token is resolved into a local token, within the context of the external module [S3005]. The resulting token is searched in the list [S3006], and if it doesn't exist, a new metadata record is created and added to the list [S3007]. The process ends in step S3008.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

1. A method for analyzing calls in an executable computer program, comprising:
determining if a call is intercepted in a native processor code;
analyzing intermediate language code of a function if the call is not intercepted in the native processor code; and
checking each function for an exception clause.

2. The method of claim 1, further comprising:
determining type behavior of the call if the call is intercepted in the native processor code.

3. A method for registering calls in an executable computer program, comprising:
determining if a call is implemented in a managed code or a native processor code;
searching for an existing call to a function if the call is implemented in the managed code; and
adding a new call record if the call does not exist; and
linking an outgoing argument of the call to an incoming argument of the call.

4. The method of claim 3, further comprising:
returning an existing call record if the call exists.

5. The method of claim 3, further comprising:
determining if the call is reflective based on an argument, if the call is implemented in the native processor code; and
iterating through each metadata token, if the call is reflective.

6. The method of claim 5, wherein a new call record is created if iterating through each metadata token does not yield a match.

7. The method of claim 3, wherein an existing call record is used to link the argument.

8. A method for linking nodes in a program to designate a source to target relationship, comprising:
determining if a link between a target node and source node already exists; and
creating a link between a target node and a source node if the link does not exist.

9. The method of claim 8 wherein if a target node has a virtual call then the virtual call is resolved using the source node.

10. The method of claim 8, wherein a sub-node of a source node is linked to a sub-node of a target node.

11. A method for resolving virtual functions calls in a computer program, comprising:
resolving a target function for a given virtual function;
registering a call to the target function; and
iterating an implicit type.

12. The method of claim 11, wherein the target function is resolved if the implicit type is derived from a virtual type.

13. The method of claim 11, wherein a metadata is recorded for the target function after the virtual function is resolved.

14. A method for handling direct calls to a function, comprising:
registering a call to a target function;
initializing a value node for each type; and
linking the value node to an argument node of the target function.

15. The method of claim 14, wherein if the target function returns a value, then the return value is sent to a type stack.

16. A method for handling virtual functional calls in a program, comprising:
determining if a type containing the virtual function call is marked as sealed; registering metadata for virtual function if the virtual function call is not marked as sealed; and
creating a virtual call block record.

17. The method of claim 16 wherein the virtual function call is treated as a direct call if the virtual function call is marked as sealed.

18. The method of claim 16, wherein plural arguments of the virtual function calls are iterated and if a method referenced by the virtual function call contains a return value then the return value is sent to a type stack.

19. A method for registering a metadata routine in a program, comprising: determining if a local token describes an external reference table; and resolving a reference module by name if the local token describes an external reference table.

20. The method of claim 19, wherein if the reference module is not in an existing list of modules, then a record module is created.

21. The method of claim 19, wherein if the reference module is in an existing list, then an external token is resolved into a local token.

22. A computer-readable medium storing computer-executable process steps for analyzing calls in an executable computer program, comprising:
determining if a call is intercepted in a native processor code;
analyzing intermediate language code of a function if the call is not intercepted in the native processor code; and
checking each function for an exception clause.

23. The computer-readable medium of claim 22, further comprising:
determining type behavior of the call if the call is intercepted in the native processor code.

24. A computer-readable medium storing computer-executable process steps for registering calls in an executable computer program, comprising:
determining if a call is implemented in a managed code or a native processor code;
searching for an existing call to a function if the call is implemented in the managed code; and
adding a new call record if the call does not exist; and
linking an outgoing argument of the call to an incoming argument of the call.

25. The computer-readable medium of claim 24, further comprising:
returning an existing call record if the call exists.

26. The computer-readable medium of claim 24, further comprising:
determining if the call is reflective based on an argument, if the call is implemented in the native processor code; and
iterating through each metadata token, if the call is reflective.

27. The computer-readable medium of claim 26, wherein a new call record is created if iterating through each metadata token does not yield a match.

28. The computer-readable medium of claim 24, wherein an existing call record is used to link the argument.

29. A computer-readable medium storing computer-executable process steps for linking nodes in a program to designate a source to target relationship, comprising:
determining if a link between a target node and source node already exists; and
creating a link between a target node and a source node if the link does not exist.

30. The computer-readable medium of claim 29 wherein if a target node has a virtual call then the virtual call is resolved using the source node.

31. The computer-readable medium of claim 29, wherein a sub-node of a source node is linked to a sub-node of a target node.

32. A computer-readable medium storing computer-executable process steps for resolving virtual functions calls in a computer program, comprising:
resolving a target function for a given virtual function;
registering a call to the target function; and
iterating an implicit type.

33. The computer-readable medium of claim 32, wherein the target function is resolved if the implicit type is derived from a virtual type.

34. The computer-readable medium of claim 32, wherein a metadata is recorded for the target function after the virtual function is resolved.

35. A computer-readable medium storing computer-executable process steps for handling direct calls to a function, comprising:
registering a call to a target function;
initializing a value node for each type; and
linking the value node to an argument node of the target function.

36. The computer-readable medium of claim 35, wherein if the target function returns a value, then the return value is sent to a type stack.

37. A computer-readable medium storing computer-executable process steps for handling virtual functional calls in a program, comprising:
determining if a type containing the virtual function call is marked as sealed;
registering metadata for virtual function if the virtual function call is not marked as sealed; and
creating a virtual call block record.

38. The computer-readable medium of claim 37 wherein the virtual function call is treated as a direct call if the virtual function call is marked as sealed.

39. The computer-readable medium of claim 37, wherein plural arguments of the virtual function calls are iterated and if a method referenced by the virtual function call contains a return value then the return value is sent to a type stack.

40. A computer-readable medium storing computer-executable process steps for registering a metadata routine in a program, comprising:
determining if a local token describes an external reference table; and resolving a reference module by name if the local token describes an external reference table.

41. The computer-readable medium of claim 40, wherein if the reference module is not in an existing list of modules, then a record module is created.

42. The computer-readable medium of claim 40, wherein if the reference module is in an existing list, then an external token is resolved into a local token.
